(19) United States
(12) Patent Application Publication
(10) Pub. No.: US 2024/0323788 A1
(43) Pub. Date: Sep. 26, 2024

(54) METHODS AND APPARATUSES FOR HANDOVER BETWEEN DIFFERENT RATS

(71) Applicant: Telefonaktiebolaget LM Ericsson (publ), Stockholm (SE)

(72) Inventors: Lei XIA, Shanghai (CN); Xiaoming LI, Shanghai (CN); Xuemei ZHANG, Shanghai (CN); Ce ZHANG, Shanghai (CN); Nianshan SHI, JÄRFÄLLA (SE)

(73) Assignee: Telefonaktiebolaget LM Ericsson (publ), Stockholm (SE)

(21) Appl. No.: 18/271,620

(22) PCT Filed: Nov. 29, 2021
(86) PCT No.: PCT/EP2021/083305

§ 371 Date: Jul. 10, 2023

(30) Foreign Application Priority Data
Jan. 11, 2021 (WO) PCT/CN2021/071111

(51) Int. Cl. H04W 36/14

(52) U.S. Cl. CPC H04W 36/144

(57) ABSTRACT

Methods and apparatuses for handover between different radio access technologies (RATs) are disclosed. According to an embodiment, an access network node receives, from a mobility management entity (MME), information indicating that one or more bearers for a terminal device cannot be handed over to one or more RATs different than long term evolution (LTE). The access network node determines whether to perform a packet switched (PS) handover for the terminal device based on the information.

### TECHNICAL FIELD

Embodiments of the disclosure generally relate to communication, and, more particularly, to methods and apparatuses for handover between different radio access technologies (RATs).

### BACKGROUND

This section introduces aspects that may facilitate better understanding of the present disclosure. Accordingly, the statements of this section are to be read in this light and are not to be understood as admissions about what is in the prior art or what is not in the prior art.

In 4th generation (4G)/long term evolution (LTE), the operators need to access circuit switched (CS) services via evolved packet system (EPS) network. The voice call support could be a typical use case of communication service for accessing CS domain.

FIG. 1 illustrates an architecture in which access of CS services via EPS network is supported. The SGs interface shown in FIG. 1 connects the mobile switching center (MSC)/visitor location register (VLR) and the mobile management entity (MME)/serving GPRS support node (SGSN). The term GPRS refers to general packet radio service. The SGs interface is used for registration in the MSC/VLR of the user equipment (UE) by performing combined procedures, to page the UE on behalf of the MSC/VLR, and to convey CS-related services. By using the SGs interface, the CS call could fall back to wideband code division multiple access (WCDMA) and global system for mobile communication (GSM) to perform voice calls for a UE initially connected to EPS. Short message service (SMS) can be transmitted between the UE and the MSC through the MME via the SGs interface.

After introducing voice over LTE (packet switched (PS) data) and SMS over Internet protocol (IP) in protocol, there is another method for the network to provide voice and SMS services over IP multimedia subsystem (IMS). The IMS uses an IMS packet data network (PDN) through MME, gateway (GW) and IMS server, and does not need SGs interface, but uses Sv interface instead. When a UE with an on-going voice call on an IMS PDN moves from LTE to 2nd generation (2G)/3rd generation (3G), single radio voice call continuity (SRVCC) procedure using Sv interface defined by the 3rd generation partnership project (3GPP) will be triggered to handover the UE to 2/3G.

The SRVCC procedure has two kinds. The first kind is SRVCC without PS handover, in which MME only hands over the voice bearer to MSC CS domain via Sv, and other bearers are transferred to PS domain in WCDMA or GSM network through a route area update (RAU) procedure. The second kind is SRVCC with PS handover, in which MME hands over the voice bearer to MSC CS domain via Sv and hands over other bearers to SGSN through 4G-2/3G inter-radio access technology (IRAT) PS handover procedure. Which kind of SRVCC will be applied by MME is decided by evolved node B (eNodeB). The eNodeB sends an information element (IE) “SRVCC handover (HO) Indication” with value: “PS and CS” or “CS only” in Handover Required message to MME.

3GPP supports inter-system handover between 4G and 5th generation (5G) while protocol data unit (PDU) sessions in 5G can be handed over to 4G as evolved radio access bearers (E-RABs) and vice versa. 3GPP also supports inter-system handover between 4G and 2/3G.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for handover between different RATs. In particular, one of the problems to be solved by the disclosure is that the existing solution may result in a failure of SRVCC or PS handover procedure because some bearers cannot be handed over between LTE and 2/3G or 5G.

According to a first aspect of the disclosure, there is provided a method performed by an access network node. The method may comprise receiving, from an MME, information indicating that one or more bearers for a terminal device cannot be handed over to one or more RATs different than LTE. The method may further comprise determining whether to perform a PS handover for the terminal device based on the information.

In this way, it is possible to avoid a failure of a PS handover to one or more RATs different than LTE so as to improve the end user experience especially for voice service.

In an embodiment of the disclosure, the method may further comprise determining how to perform the PS handover for the terminal device based on the information.

In an embodiment of the disclosure, the information may indicate that the one or more bearers for the terminal device cannot be handed over to 2G/3G or 5G.

In an embodiment of the disclosure, the one or more bearers may comprise at least one first bearer established in LTE and capable of interworking with 5th generation system (5GS). The information may indicate that the at least one first bearer cannot be handed over to 2G/3G.

In an embodiment of the disclosure, the one or more bearers may comprise at least one second bearer established in LTE and incapable of interworking with 5GS. The information may indicate that the at least one second bearer cannot be handed over to 5G.

In an embodiment of the disclosure, the one or more bearers may comprise at least one third bearer handed over from 5G to LTE. The information may indicate that the at least one third bearer cannot be handed over to 2G/3G.

In an embodiment of the disclosure, the one or more bearers may comprise at least one fourth bearer handed over from 2G/3G to LTE. The information may indicate that the at least one fourth bearer cannot be handed over to 5G.

In an embodiment of the disclosure, determining whether to perform a PS handover for the terminal device based on the information may comprise, when the information indicates that none of the one or more bearers can be handed over to 2G/3G or 5G, determining not to perform a PS handover to 2G/3G or 5G for the one or more bearers. Alternatively or additionally, determining whether to perform a PS handover for the terminal device based on the information may comprise, when the information indicates that at least one of the one or more bearers can be handed over to 2G/3G or 5G, determining to perform a PS handover to 2G/3G or 5G for the at least one bearer.

In an embodiment of the disclosure, the PS handover may be associated with an SRVCC procedure.

In an embodiment of the disclosure, determining how to perform the PS handover for the terminal device based on the information may comprise determining a target radio access network (RAN) for the PS handover based on the information.

In an embodiment of the disclosure, the information may be received in one of: an E-RAB Setup Request; an Initial Context Setup Request; and a Handover Request.

According to a second aspect of the disclosure, there is provided a method performed by an MME. The method may comprise sending, to an access network node, information indicating that one or more bearers for a terminal device cannot be handed over to one or more RATs different than LTE.

In this way, it is possible to avoid a failure of a PS handover to one or more RATs different than LTE so as to improve the end user experience especially for voice service.

In an embodiment of the disclosure, the information may indicate that the one or more bearers for the terminal device cannot be handed over to 2G/3G or 5G.

In an embodiment of the disclosure, the one or more bearers may comprise at least one first bearer established in LTE and capable of interworking with 5GS. The information may indicate that the at least one first bearer cannot be handed over to 2G/3G.

In an embodiment of the disclosure, the one or more bearers may comprise at least one second bearer established in LTE and incapable of interworking with 5GS. The information may indicate that the at least one second bearer cannot be handed over to 5G.

In an embodiment of the disclosure, the one or more bearers may comprise at least one third bearer handed over from 5G to LTE. The information may indicate that the at least one third bearer cannot be handed over to 2G/3G.

In an embodiment of the disclosure, the one or more bearers may comprise at least one fourth bearer handed over from 2G/3G to LTE. The information may indicate that the at least one fourth bearer cannot be handed over to 5G.

In an embodiment of the disclosure, the information may be sent in one of: an E-RAB Setup Request; an Initial Context Setup Request; and a Handover Request.

According to a third aspect of the disclosure, there is provided a method performed by an access network node. The method may comprise receiving, from an MME, an indication about whether both CS handover and PS handover of SRVCC to 2G/3G or only CS handover of SRVCC to 2G/3G is supported by a terminal device. The method may further comprise performing at least one handover to 2G/3G for the terminal device based on the indication.

In this way, it is possible to avoid a failure of an SRVCC procedure to 2G/3G so as to improve the end user experience especially for voice service.

In an embodiment of the disclosure, performing at least one handover to 2G/3G for the terminal device based on the indication may comprise, when the indication indicates that both CS handover and PS handover of SRVCC to 2G/3G is supported by the terminal device, performing both a CS handover and a PS handover in an SRVCC procedure for the terminal device. Alternatively or additionally, performing at least one handover to 2G/3G for the terminal device based on the indication may comprise, when the indication indicates that only CS handover of SRVCC to 2G/3G is supported by the terminal device, performing a CS handover without a PS handover in an SRVCC procedure for the terminal device.

In an embodiment of the disclosure, the indication may be received in one of: a Downlink non-access stratum (NAS) Transport message; an E-RAB Setup Request; an Initial Context Setup Request; a Handover Request; a Path Switch Request Acknowledge message; an E-RAB Release Command; and a UE Context Modification Request.

In an embodiment of the disclosure, the indication may be received in response to one of: the support by the terminal device for both CS handover and PS handover of SRVCC to 2G/3G or only CS handover of SRVCC to 2G/3G is changed; the terminal device turns from idle state to connected state; a serving access network node of the terminal device is changed from another access network node to the access network node; and a serving RAN of the terminal device is changed from a 5G RAN to an LTE RAN.

According to a fourth aspect of the disclosure, there is provided a method performed by an MME. The method may comprise sending, to an access network node, an indication about whether both CS handover and PS handover of SRVCC to 2G/3G or only CS handover of SRVCC to 2G/3G is supported by a terminal device.

In this way, it is possible to avoid a failure of an SRVCC procedure to 2G/3G so as to improve the end user experience especially for voice service.

In an embodiment of the disclosure, both CS handover and PS handover of SRVCC to 2G/3G may be supported by the terminal device when at least one of one or more bearers for the terminal device can be handed over to 2G/3G. Alternatively or additionally, only CS handover of SRVCC to 2G/3G may be supported by the terminal device when none of the one or more bearers for the terminal device can be handed over to 2G/3G.

In an embodiment of the disclosure, the indication may be sent in one of: a Downlink NAS Transport message; an E-RAB Setup Request; an Initial Context Setup Request; a Handover Request; a Path Switch Request Acknowledge message; an E-RAB Release Command; and a UE Context Modification Request.

In an embodiment of the disclosure, the indication may be sent in response to one of: the support by the terminal device for both CS handover and PS handover of SRVCC to 2G/3G or only CS handover of SRVCC to 2G/3G is changed; the terminal device turns from idle state to connected state; a serving access network node of the terminal device is changed from another access network node to the access network node; and a serving RAN of the terminal device is changed from a 5G RAN to an LTE RAN.

According to a fifth aspect of the disclosure, there is provided a method performed by an access network node. The method may comprise detecting a trigger event that a first request for a CS handover has been received, but a second request for a PS handover has not been received within a predetermined time period in a case where both the CS handover and the PS handover need to be performed in an SRVCC procedure. The method may further comprise, in response to the trigger event, sending a response for approving the CS handover.

In this way, it is possible to avoid a failure of an SRVCC procedure to 2G/3G so as to improve the end user experience especially for voice service.

According to a sixth aspect of the disclosure, there is provided a method performed by an MME. The method may comprise receiving, from an access network node, a first message indicating that both CS handover and PS handover are required for a terminal device in an SRVCC procedure. The method may further comprise determining whether none of one or more bearers for the terminal device can be handed over to 2G/3G. The method may further comprise, when determining that none of the one or more bearers for the terminal device can be handed over to 2G/3G, sending, to the access network node, a second message indicating a failure of handover preparation due to both CS handover and PS handover to 2G/3G being not supported by the terminal device.

In this way, it is possible to avoid a long latency for an SRVCC procedure so as to improve the end user experience especially for voice service.

In an embodiment of the disclosure, the failure of handover preparation due to both CS handover and PS handover to 2G/3G being not supported by the terminal device may be indicated by a failure cause and/or an indication bit.

According to a seventh aspect of the disclosure, there is provided a method performed by a n access network node. The method may comprise sending, to an MME, a first message indicating that both CS handover and PS handover are required for a terminal device in an SRVCC procedure. The method may further comprise receiving, from the MME, a second message indicating a failure of handover preparation due to both CS handover and PS handover to 2G/3G being not supported by the terminal device. The method may further comprise sending, to the MME, a third message indicating that only CS handover is required for the terminal device in the SRVCC procedure.

In this way, it is possible to avoid a long latency for an SRVCC procedure to 2G/3G so as to improve the end user experience especially for voice service.

In an embodiment of the disclosure, the failure of handover preparation due to both CS handover and PS handover to 2G/3G being not supported by the terminal device may be indicated by a failure cause and/or an indication bit.

According to an eighth aspect of the disclosure, there is provided a method performed by an access network node. The method may comprise, when one or more bearers for a terminal device are handed over from 5G to LTE, saving information indicating that the one or more bearers cannot be handed over to 2G/3G. The method may further comprise excluding the one or more bearers indicated by the saved information, when determining which bearer(s) for the terminal device are to be handed over to 2G/3G in a PS handover or in an SRVCC procedure.

In this way, it is possible to avoid a failure of an SRVCC procedure to 2G/3G so as to improve the end user experience especially for voice service.

According to a ninth aspect of the disclosure, there is provided a method performed by an access and mobility management function (AMF). The method may comprise, when one or more bearers for a terminal device are to be handed over from 5G to LTE, determining one or more fake transaction identifiers (TIs) for the one or more bearers. The method may further comprise sending the one or more fake TIs for the one or more bearers to an MME.

In this way, it is possible to avoid a failure of an SRVCC procedure to 2G/3G so as to improve the end user experience especially for voice service.

According to a tenth aspect of the disclosure, there is provided a method performed by an MME. The method may comprise receiving, from a source access network node, a message indicating that both CS handover and PS handover are required for a terminal device in an SRVCC procedure. The message may comprise a transparent container destined to a target access network node. The transparent container may contain a first indicator indicating that a number of instances between the target access network node and a corresponding target core network is two. The method may further comprise replacing the first indicator in the transparent container with a second indicator indicating that the number of instances between the target access network node and the corresponding target core network is one. The method may further comprise transferring the transparent container having the second indicator to the target access network node.

In this way, it is possible to avoid a failure of an SRVCC procedure to 2G/3G so as to improve the end user experience especially for voice service.

According to an eleventh aspect of the disclosure, there is provided an access network node. The access network node may comprise at least one processor and at least one memory. The at least one memory may contain instructions executable by the at least one processor, whereby the access network node may be operative to receive, from an MME, information indicating that one or more bearers for a terminal device cannot be handed over to one or more RATs different than LTE. The access network node may be further operative to determine whether to perform a PS handover for the terminal device based on the information.

In an embodiment of the disclosure, the access network node may be operative to perform the method according to the above first aspect.

According to a twelfth aspect of the disclosure, there is provided an MME. The MME may comprise at least one processor and at least one memory. The at least one memory may contain instructions executable by the at least one processor, whereby the MME may be operative to send, to an access network node, information indicating that one or more bearers for a terminal device cannot be handed over to one or more RATs different than LTE.

In an embodiment of the disclosure, the MME may be operative to perform the method according to the above second aspect.

According to a thirteenth aspect of the disclosure, there is provided an access network node. The access network node may comprise at least one processor and at least one memory. The at least one memory may contain instructions executable by the at least one processor, whereby the access network node may be operative to receive, from an MME, an indication about whether both CS handover and PS handover of SRVCC to 2G/3G or only CS handover of SRVCC to 2G/3G is supported by a terminal device. The access network node may be further operative to perform at least one handover to 2G/3G for the terminal device based on the indication.

In an embodiment of the disclosure, the access network node may be operative to perform the method according to the above third aspect.

According to a fourteenth aspect of the disclosure, there is provided an MME. The MME may comprise at least one processor and at least one memory. The at least one memory may contain instructions executable by the at least one processor, whereby the MME may be operative to send, to an access network node, an indication about whether both CS handover and PS handover of SRVCC to 2G/3G or only CS handover of SRVCC to 2G/3G is supported by a terminal device.

In an embodiment of the disclosure, the MME may be operative to perform the method according to the above fourth aspect.

According to a fifteenth aspect of the disclosure, there is provided an access network node. The access network node may comprise at least one processor and at least one memory. The at least one memory may contain instructions executable by the at least one processor, whereby the access network node may be operative to detect a trigger event that a first request for a CS handover has been received, but a second request for a PS handover has not been received within a predetermined time period in a case where both the CS handover and the PS handover need to be performed in an SRVCC procedure. The access network node may be further operative to, in response to the trigger event, send a response for approving the CS handover.

According to a sixteenth aspect of the disclosure, there is provided an MME. The MME may comprise at least one processor and at least one memory. The at least one memory may contain instructions executable by the at least one processor, whereby the MME may be operative to receive, from an access network node, a first message indicating that both CS handover and PS handover are required for a terminal device in an SRVCC procedure. The MME may be further operative to determine whether none of one or more bearers for the terminal device can be handed over to 2G/3G. The MME may be further operative to, when determining that none of the one or more bearers for the terminal device can be handed over to 2G/3G, send, to the access network node, a second message indicating a failure of handover preparation due to both CS handover and PS handover to 2G/3G being not supported by the terminal device.

In an embodiment of the disclosure, the MME may be operative to perform the method according to the above sixth aspect.

According to a seventeenth aspect of the disclosure, there is provided an access network node. The access network node may comprise at least one processor and at least one memory. The at least one memory may contain instructions executable by the at least one processor, whereby the access network node may be operative to send, to an MME, a first message indicating that both CS handover and PS handover are required for a terminal device in an SRVCC procedure. The access network node may be further operative to receive, from the MME, a second message indicating a failure of handover preparation due to both CS handover and PS handover to 2G/3G being not supported by the terminal device. The access network node may be further operative to send, to the MME, a third message indicating that only CS handover is required for the terminal device in the SRVCC procedure.

In an embodiment of the disclosure, the access network node may be operative to perform the method according to the above seventh aspect.

According to an eighteenth aspect of the disclosure, there is provided an access network node. The access network node may comprise at least one processor and at least one memory. The at least one memory may contain instructions executable by the at least one processor, whereby the access network node may be operative to, when one or more bearers for a terminal device are handed over from 5G to LTE, save information indicating that the one or more bearers cannot be handed over to 2G/3G. The access network node may be further operative to exclude the one or more bearers indicated by the saved information, when determining which bearer(s) for the terminal device are to be handed over to 2G/3G in a PS handover or in an SRVCC procedure.

According to a nineteenth aspect of the disclosure, there is provided an AMF. The AMF may comprise at least one processor and at least one memory. The at least one memory may contain instructions executable by the at least one processor, whereby the AMF may be operative to, when one or more bearers for a terminal device are to be handed over from 5G to LTE, determine one or more fake TIs for the one or more bearers. The AMF may be further operative to send the one or more fake TIs for the one or more bearers to an MME.

According to a twentieth aspect of the disclosure, there is provided an MME. The MME may comprise at least one processor and at least one memory. The at least one memory may contain instructions executable by the at least one processor, whereby the MME may be operative to receive, from a source access network node, a message indicating that both CS handover and PS handover are required for a terminal device in an SRVCC procedure. The message may comprise a transparent container destined to a target access network node. The transparent container may contain a first indicator indicating that a number of instances between the target access network node and a corresponding target core network is two. The MME may be further operative to replace the first indicator in the transparent container with a second indicator indicating that the number of instances between the target access network node and the corresponding target core network is one. The MME may be further operative to transfer the transparent container having the second indicator to the target access network node.

According to a twenty-first aspect of the disclosure, there is provided a computer program product. The computer program product may comprise instructions which when executed by at least one processor, cause the at least one processor to perform the method according to any of the above first to tenth aspects.

According to a twenty-second aspect of the disclosure, there is provided a computer readable storage medium. The computer readable storage medium may comprise instructions which when executed by at least one processor, cause the at least one processor to perform the method according to any of the above first to tenth aspects.

According to a twenty-third aspect of the disclosure, there is provided an access network node. The access network node may comprise a reception module for receiving, from an MME, information indicating that one or more bearers for a terminal device cannot be handed over to one or more RATs different than LTE. The access network node may further comprise a determination module for determining whether to perform a PS handover for the terminal device based on the information.

According to a twenty-fourth aspect of the disclosure, there is provided an MME. The MME may comprise a sending module for sending, to an access network node, information indicating that one or more bearers for a terminal device cannot be handed over to one or more RATs different than LTE.

According to a twenty-fifth aspect of the disclosure, there is provided an access network node. The access network node may comprise a reception module for receiving, from an MME, an indication about whether both CS handover and PS handover of SRVCC to 2G/3G or only CS handover of SRVCC to 2G/3G is supported by a terminal device. The access network node may further comprise a handover module for performing at least one handover to 2G/3G for the terminal device based on the indication.

According to a twenty-sixth aspect of the disclosure, there is provided an MME. The MME may comprise a sending module for sending, to an access network node, an indication about whether both CS handover and PS handover of SRVCC to 2G/3G or only CS handover of SRVCC to 2G/3G is supported by a terminal device.

According to a twenty-seventh aspect of the disclosure, there is provided an access network node. The access network node may comprise a detection module for detecting a trigger event that a first request for a CS handover has been received, but a second request for a PS handover has not been received within a predetermined time period in a case where both the CS handover and the PS handover need to be performed in an SRVCC procedure. The access network node may further comprise a sending module for, in response to the trigger event, sending a response for approving the CS handover.

According to a twenty-eighth aspect of the disclosure, there is provided an MME. The MME may comprise a reception module for receiving, from an access network node, a first message indicating that both CS handover and PS handover are required for a terminal device in an SRVCC procedure. The MME may further comprise a determination module for determining whether none of one or more bearers for the terminal device can be handed over to 2G/3G. The MME may further comprise a sending module for, when determining that none of the one or more bearers for the terminal device can be handed over to 2G/3G, sending, to the access network node, a second message indicating a failure of handover preparation due to both CS handover and PS handover to 2G/3G being not supported by the terminal device.

According to a twenty-ninth aspect of the disclosure, there is provided an access network node. The access network node may comprise a first sending module for sending, to an MME, a first message indicating that both CS handover and PS handover are required for a terminal device in an SRVCC procedure. The access network node may further comprise a reception module for receiving, from the MME, a second message indicating a failure of handover preparation due to both CS handover and PS handover to 2G/3G being not supported by the terminal device. The access network node may further comprise a second sending module for sending, to the MME, a third message indicating that only CS handover is required for the terminal device in the SRVCC procedure.

According to a thirtieth aspect of the disclosure, there is provided an access network node. The access network node may comprise a saving module for, when one or more bearers for a terminal device are handed over from 5G to LTE, saving information indicating that the one or more bearers cannot be handed over to 2G/3G. The access network node may further comprise an excluding module for excluding the one or more bearers indicated by the saved information, when determining which bearer(s) for the terminal device are to be handed over to 2G/3G in a PS handover or in an SRVCC procedure.

According to a thirty-first aspect of the disclosure, there is provided an AMF. The AMF may comprise a determination module for, when one or more bearers for a terminal device are to be handed over from 5G to LTE, determining one or more fake TIs for the one or more bearers. The AMF may further comprise a sending module for sending the one or more fake TIs for the one or more bearers to an MME.

According to a thirty-second aspect of the disclosure, there is provided an MME. The MME may comprise a reception module for receiving, from a source access network node, a message indicating that both CS handover and PS handover are required for a terminal device in an SRVCC procedure. The message may comprise a transparent container destined to a target access network node. The transparent container may contain a first indicator indicating that a number of instances between the target access network node and a corresponding target core network is two. The MME may further comprise a replacing module for replacing the first indicator in the transparent container with a second indicator indicating that the number of instances between the target access network node and the corresponding target core network is one. The MME may further comprise a transferring module for transferring the transparent container having the second indicator to the target access network node.

According to a thirty-third aspect of the disclosure, there is provided a method implemented in a communication system including an access network node and an MME. The method may comprise all steps of the methods according to the above first and second aspects.

According to a thirty-fourth aspect of the disclosure, there is provided a communication system. The communication system may comprise an access network node according to the above eleventh or twenty-third aspect and an MME according to the above twelfth or twenty-fourth aspect.

According to a thirty-fifth aspect of the disclosure, there is provided a method implemented in a communication system including an access network node and an MME. The method may comprise all steps of the methods according to the above third and fourth aspects.

According to a thirty-sixth aspect of the disclosure, there is provided a communication system. The communication system may comprise an access network node according to the above thirteenth or twenty-fifth aspect and an MME according to the above fourteenth or twenty-sixth aspect.

According to a thirty-seventh aspect of the disclosure, there is provided a method implemented in a communication system including an MME and an access network node. The method may comprise all steps of the methods according to the above sixth and seventh aspects.

According to a thirty-eighth aspect of the disclosure, there is provided a communication system. The communication system may comprise an MME according to the above sixteenth or twenty-eighth aspect and an access network node according to the above seventeenth or twenty-ninth aspect.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating an architecture in which access of CS services via EPS network is supported;

FIG. 2 is a diagram illustrating a problem with the existing solution;

FIG. 3 is a flowchart illustrating a method performed by an access network node according to an embodiment of the disclosure;

FIG. 4 is a flowchart for explaining the method of FIG. 3;

FIG. 5 is a flowchart illustrating a method performed by an access network node according to an embodiment of the disclosure;

FIG. 6 is a flowchart illustrating a method performed by an MME according to an embodiment of the disclosure;

FIG. 7 is a flowchart illustrating an exemplary process according to an embodiment of the disclosure;

FIG. 8 is a flowchart illustrating an exemplary process according to an embodiment of the disclosure;

FIG. 9 is a flowchart illustrating an exemplary process according to an embodiment of the disclosure;

FIG. 10 is a flowchart illustrating an exemplary process according to an embodiment of the disclosure;

FIG. 11 is a flowchart illustrating a method performed by an access network node according to an embodiment of the disclosure;

FIG. 12 is a flowchart for explaining the method of FIG. 11;

FIG. 13 is a flowchart illustrating a method performed by an MME according to an embodiment of the disclosure;

FIG. 14 is a flowchart illustrating an exemplary process according to an embodiment of the disclosure;

FIG. 15 is a flowchart illustrating an exemplary process according to an embodiment of the disclosure;

FIG. 16 is a flowchart illustrating a method performed by an access network node according to an embodiment of the disclosure;

FIG. 17 is a flowchart illustrating a method performed by an MME according to an embodiment of the disclosure;

FIG. 18 is a flowchart illustrating a method performed by an access network node according to an embodiment of the disclosure;

FIG. 19 is a flowchart illustrating a method performed by an access network node according to an embodiment of the disclosure;

FIG. 20 is a flowchart illustrating a method performed by an AMF according to an embodiment of the disclosure;

FIG. 21 is a flowchart illustrating a method performed by an MME according to an embodiment of the disclosure;

FIG. 22 is a block diagram showing an apparatus suitable for use in practicing some embodiments of the disclosure;

FIG. 23 is a block diagram showing an access network node according to an embodiment of the disclosure;

FIG. 24 is a block diagram showing an MME according to an embodiment of the disclosure;

FIG. 25 is a block diagram showing an access network node according to an embodiment of the disclosure;

FIG. 26 is a block diagram showing an MME according to an embodiment of the disclosure;

FIG. 27 is a block diagram showing an access network node according to an embodiment of the disclosure;

FIG. 28 is a block diagram showing an MME according to an embodiment of the disclosure;

FIG. 29 is a block diagram showing an access network node according to an embodiment of the disclosure;

FIG. 30 is a block diagram showing an access network node according to an embodiment of the disclosure;

FIG. 31 is a block diagram showing an AMF according to an embodiment of the disclosure; and

FIG. 32 is a block diagram showing an MME according to an embodiment of the disclosure.

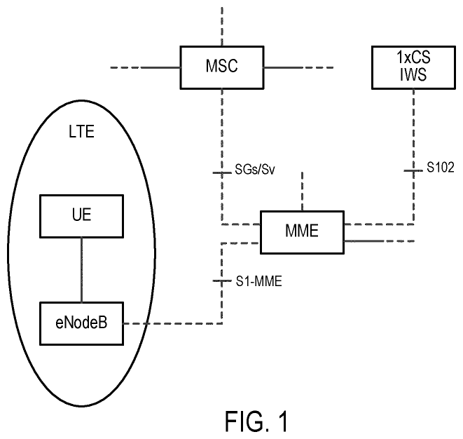

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

As used herein, the terminal device may also be referred to as, for example, device, access terminal, user equipment (UE), mobile station, mobile unit, subscriber station, or the like. It may refer to any end device that can access a wireless communication network and receive services therefrom. By way of example and not limitation, the terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, a terminal device may represent a machine or other device that performs monitoring and/or measurements, and transmits the results of such monitoring and/or measurements to another terminal device and/or a network equipment. In this case, the terminal device may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

The term “communication system” refers to a system following any suitable communication standards, such as the first generation (1G), 2G, 2.5G, 2.75G, 3G, 4G, 4.5G, 5G communication protocols, and/or any other protocols either currently known or to be developed in the future. Furthermore, the communications between a terminal device and a network node in the communication system may be performed according to any suitable generation communication protocols, including, but not limited to, 1G, 2G, 2.5G, 2.75G, 3G, 4G, 4.5G, 5G communication protocols, and/or any other protocols either currently known or to be developed in the future. In addition, the specific terms used herein do not limit the present disclosure only to the communication system related to the specific terms, which however can be more generally applied to other communication systems.

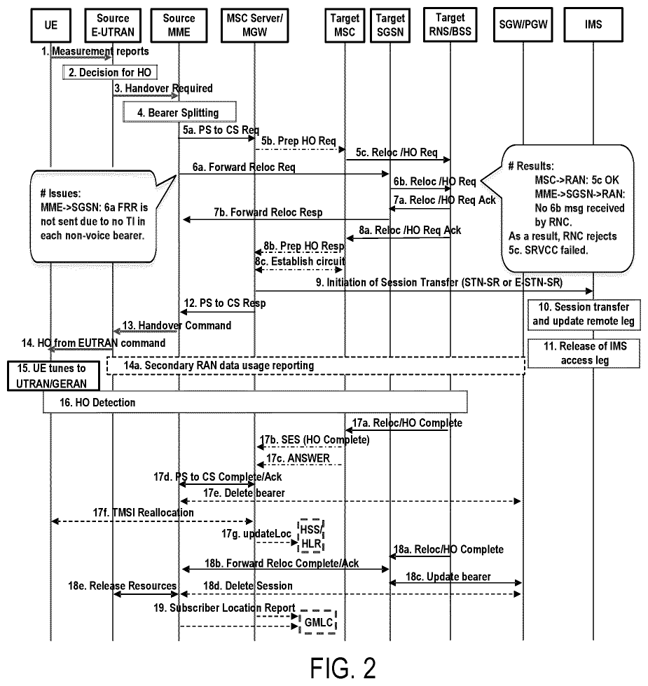

FIG. 2 illustrates a problem with the existing solution. In the customer network, there is one case: when a UE moves from 5G to LTE, both one IMS PDN with a voice bearer and other normal PDNs of the UE are handed over successfully to LTE. Later, the UE moves to 3G and the eNodeB triggers SRVCC with PS handover procedure. But due to all the non-voice bearers being not allocated with transaction identifiers (TIs) in 5G, the MME cannot send them in Forward Relocation Request message to the SGSN and no Forward Relocation Request message will be sent to the SGSN. Then PS handover is failed. When the target radio network controller (RNC) in 3G is notified that it is CS+PS handover according to “Number of Iu Instances IE=2 (meaning CS+PS)” in IE “Source to Target Transparent Container” sent by the eNodeB and received in step 5c of FIG. 2, the RNC always waits for PS bearers coming in step 6b. The target RNC may send a reject response to the MSC after no PS bearers come. The whole SRVCC procedure with PS handover may be considered as failed. Then the voice bearer cannot be relocated to the target MSC in 3G either.

Note that according to the protocol, the TI for a bearer is only allocated in 2/3/4G when this bearer is set up. In 5G, when a PDU session including quality of service (QOS) flow(s) is established, no TI is allocated by the UE or the session management function (SMF). So after the UE moves from 5G to EPS, all the bearers of PDNs from 5G have no TIs. Later when the UE moves from EPS to 2/3G and triggers SRVCC with PS handover procedure, the MME cannot fill TI in Forward Relocation Request message but TI shall be filled in based on the protocol. So no Forward Relocation Request is sent to the SGSN, which causes SRVCC to be failed.

Also Note that not only bearers without TIs cannot be handed over to 2/3G, but also PDNs, which are set up in LTE with indication flag “5GSIWK” or “5GCNRI” being set to 1 and are sent to PGW-C+SMF, cannot be handed over to 2/3G, because these PDNs are allocated with 5G PDU session IDs and 5G QoS. The term 5GSIWK refers to 5GS interworking, the 5GCNRI refers to 5G core (5GC) not restricted indication, and the PGW-C refers to PDN gateway control plane. Based on the current protocol, there is no method to move them to 2/3G, because PDU session in PGW-C+SMF cannot be transferred to packet data protocol (PDP) context in gateway GPRS support node (GGSN).

When 5G is developed and deployed, there are the below issues related to the PS service continuality. For PDU sessions being set up in 5G or PDN connections with PDU session ID and 5G QoS being set up in 4G, they cannot be moved to 2/3G via 4G. The E-RABs being set up in 4G which are prepared to be handed over to 5G cannot be handed over to 2/3G. But the eNodeB (or eNB) is unaware of such restriction. According to the current 3GPP specification, the eNB will handle these E-RABs as any legacy E-RABs pre 5G time and perform handover either to 5G or 2/3G depending on, e.g. the real radio conditions. The consequence would be either long latency for SRVCC or PS handover procedure, or even dropped calls to degrade the key performance indicator (KPI).

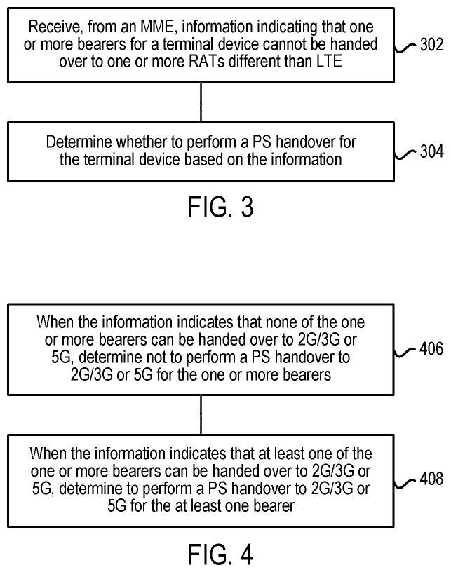

The present disclosure proposes an improved solution for handover between different RATs. The basic idea of the disclosure is to either let the eNodeB aware, or to handle it in other nodes to avoid a handover failure (e.g. latency or call drops). Hereinafter, the solution will be described in detail with reference to FIGS. 3-32.

FIG. 3 is a flowchart illustrating a method performed by an access network node according to an embodiment of the disclosure. For example, the access network node may be an eNB in LTE. Note that the network node or network function described herein can be implemented either as a network element on a dedicated hardware, as a software instance running on a dedicated hardware, or as a virtualized function instantiated on an appropriate platform, e.g. on a cloud infrastructure. At block 302, the access network node receives, from an MME, information indicating that one or more bearers for a terminal device cannot be handed over to one or more RATs different than LTE. For example, the bearer may be a radio access bearer (RAB) for the terminal device. Note that when there are multiple bearers, the information may indicate, for each of the multiple bearers, the corresponding RAT(s) to which the bearer cannot be handed over. The one or more RATs may include, but not limited to, 2G, 3G and 5G. Thus, the information may indicate that the one or more bearers for the terminal device cannot be handed over to 2G/3G or 5G.

As an example, the one or more bearers may comprise at least one first bearer established in LTE and capable of interworking with 5GS. Correspondingly, the information may indicate that the at least one first bearer cannot be handed over to 2G/3G. As another example, the one or more bearers may comprise at least one second bearer established in LTE and incapable of interworking with 5GS. Correspondingly, the information may indicate that the at least one second bearer cannot be handed over to 5G. As yet another example, the one or more bearers may comprise at least one third bearer handed over from 5G to LTE. Correspondingly, the information may indicate that the at least one third bearer cannot be handed over to 2G/3G. As yet another example, the one or more bearers may comprise at least one fourth bearer handed over from 2G/3G to LTE. Correspondingly, the information may indicate that the at least one fourth bearer cannot be handed over to 5G. As an exemplary example, the information may be received in one of an E-RAB Setup Request, an Initial Context Setup Request, and a Handover Request.

At block 304, the access network node determines whether to perform a PS handover for the terminal device based on the information. Optionally, the PS handover may be associated with an SRVCC procedure. In other words, the PS handover may be together with an SRVCC procedure for IMS voice call. For example, block 304 may be implemented as including at least one of blocks 406-408 of FIG. 4. At block 406, when the information indicates that none of the one or more bearers can be handed over to 2G/3G or 5G, the access network node determines not to perform a PS handover to 2G/3G or 5G for the one or more bearers. That is, when the information indicates that none of the one or more bearers can be handed over to 2G/3G, the access network node determines not to perform a PS handover to 2G/3G for the one or more bearers. When the information indicates that none of the one or more bearers can be handed over to 5G, the access network node determines not to perform a PS handover to 5G for the one or more bearers. At block 408, when the information indicates that at least one of the one or more bearers can be handed over to 2G/3G or 5G, the access network node determines to perform a PS handover to 2G/3G or 5G for the at least one bearer. With the method of FIG. 3, it is possible to avoid a failure of a PS handover to one or more RATs different than LTE so as to improve the end user experience especially for voice service.

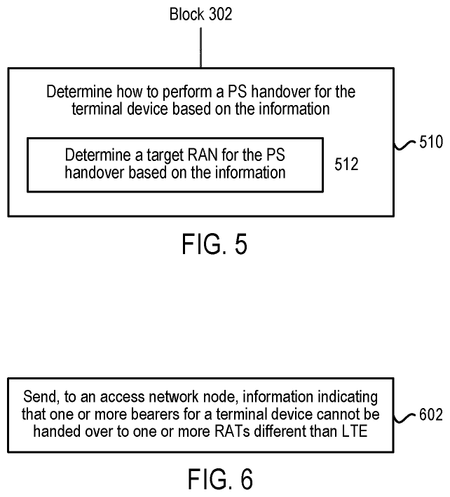

FIG. 5 is a flowchart illustrating a method performed by an access network node according to an embodiment of the disclosure. For example, the access network node may be an eNB. As shown, the method of FIG. 5 comprises block 302 described above and block 510. At block 302, the access network node receives, from an MME, information indicating that one or more bearers for a terminal device cannot be handed over to one or more RATs different than LTE. At block 510, the access network node determines how to perform a PS handover for the terminal device based on the information. For example, block 510 may include block 512. At block 512, the access network node determines a target RAN for the PS handover based on the information. For example, the target RAN may be determined as an RAN using an RAT to which the bearer(s) for the terminal device can be handed over. With the method of FIG. 5, it is possible to successfully perform a PS handover.

FIG. 6 is a flowchart illustrating a method performed by an MME according to an embodiment of the disclosure. At block 602, the MME sends, to an access network node, information indicating that one or more bearers for a terminal device cannot be handed over to one or more RATs different than LTE. For example, the bearer may be an RAB for the terminal device. Note that when there are multiple bearers, the information may indicate, for each of the multiple bearers, the corresponding RAT(s) to which the bearer cannot be handed over. The one or more RATs may include, but not limited to, 2G, 3G and 5G. Thus, the information may indicate that the one or more bearers for the terminal device cannot be handed over to 2G/3G or 5G. As an exemplary example, the information may be sent in one of an E-RAB Setup Request, an Initial Context Setup Request, and a Handover Request.

The information may be determined by the MME as below. As an example, if the one or more bearers comprise at least one first bearer established in LTE and capable of interworking with 5GS, the determined information may indicate that the at least one first bearer cannot be handed over to 2G/3G. As another example, if the one or more bearers comprise at least one second bearer established in LTE and incapable of interworking with 5GS, the determined information may indicate that the at least one second bearer cannot be handed over to 5G. As yet another example, if the one or more bearers may comprise at least one third bearer handed over from 5G to LTE, the determined information may indicate that the at least one third bearer cannot be handed over to 2G/3G. As yet another example, if the one or more bearers comprise at least one fourth bearer handed over from 2G/3G to LTE, the determined information may indicate that the at least one fourth bearer cannot be handed over to 5G. With the method of FIG. 6, it is possible to avoid a failure of a PS handover to one or more RATs different than LTE so as to improve the end user experience especially for voice service.

As an exemplary example for the methods of FIGS. 3 and 6, changes are made on both an MME and an eNodeB by the MME indicating to the eNB if each E-RAB can be handed over to 2/3G or 5G when E-RAB is setup or moved from 5G/2G/3G to LTE. The eNodeB will store this information and use it for any future SRVCC or handover decision. Specifically, when a UE moves from 5G to LTE (TAU or handover), the MME may notify the eNB that each existing E-RAB from 5G cannot be handed over to 2/3G. The similar handling may be performed for the RABs handed over from 2G/3G to LTE. The eNB will store the information and later the eNB will trigger SRVCC without PS handover to 2/3G, if all the E-RABs cannot be handed over to 2/3G.

For E-RAB setup in LTE, the MME may notify the eNB if this E-RAB can be handed over to 2/3G or not, according to if this E-RAB is allocated with a PDU session ID and 5G QoS or not. Later when the eNB decides to trigger SRVCC procedure, the eNB will initiate SRVCC without PS handover or with PS handover according to if none of the E-RABs can be handed over to 2/3G or at least one of the E-RABs can be handed over to 2/3G.

The above solution may also be extended to pure PS handover. Specifically, the MME notifies the eNB if this E-RAB can be handed over to 2/3G or not. Later when the eNB is to trigger PS handover to 2/3G, the eNB will decide to initiate PS handover or not according to if at least one of the E-RABs can be handed over to 2/3G or none of the E-RABs can be handed over to 2/3G.

When a UE with PDN(s) moves from 2/3G to LTE or sets up pure 4G PDN connection with bearers in LTE, this kind of PDN with bearers cannot move to 5G successfully either. So the MME can also notify the eNB if this E-RAB can be handed over to 5G or not during mobility or E-RAB setup. Later when the eNB is to trigger PS handover from LTE to 5G, the eNB will decide to initiate PS handover or not according to if at least one of the E-RABs can be handed over to 5G or none of the E-RABs can be handed over to 5G. Optionally, the eNB may also use this information to choose a suitable target RAN when performing handover. This can help the 4G system in choosing the PS handover target RAN.

The MME can indicate to the eNB in an S1AP messages. One implementation example is to tag the E-RAB with a flag e.g. “bearer handover restriction”. It may be specified that the eNB will store and use the information for future SRVCC and PS handover. It will be understood that the indicator can be included in other messages, in other forms, in Control plane or User plane. For example, the new IE may also be added to Initial Context Setup Request and Handover Request.

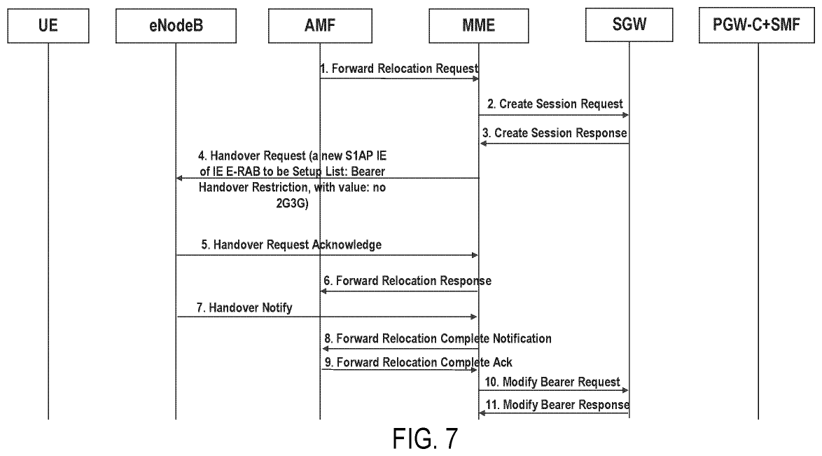

FIG. 7 is a flowchart illustrating an exemplary process according to an embodiment of the disclosure. In this process, the MME notifies the eNodeB during 5G-4G handover about handover restriction of each bearer with an indicator “Bearer Handover Restriction” with value “no 2G3G”. The process may be used for explaining the methods of FIGS. 3 and 6. At step 1, the AMF sends a Forward Relocation Request to the MME. At step 2, the MME sends a Create Session Request to the SGW. At step 3, the SGW sends a Create Session Response to the MME. At step 4, the MME sends, to the eNodeB, a Handover Request including a new S1 application protocol (S1AP) IE of IE “E-RAB to be Setup List: Bearer Handover Restriction” with value “no 2G3G”. At step 5, the eNodeB sends a Handover Request Acknowledge to the MME. At step 6, the MME sends a Forward Relocation Response to the AMF. At step 7, the eNodeB sends a Handover Notify to the MME. At step 8, the MME sends a Forward Relocation Complete Notification to the AMF. At step 9, the AMF sends a Forward Relocation Complete Ack to the MME. At step 10, the MME sends a Modify Bearer Request to the SGW. At step 11, the SGW sends a Modify Bearer Response to the MME.

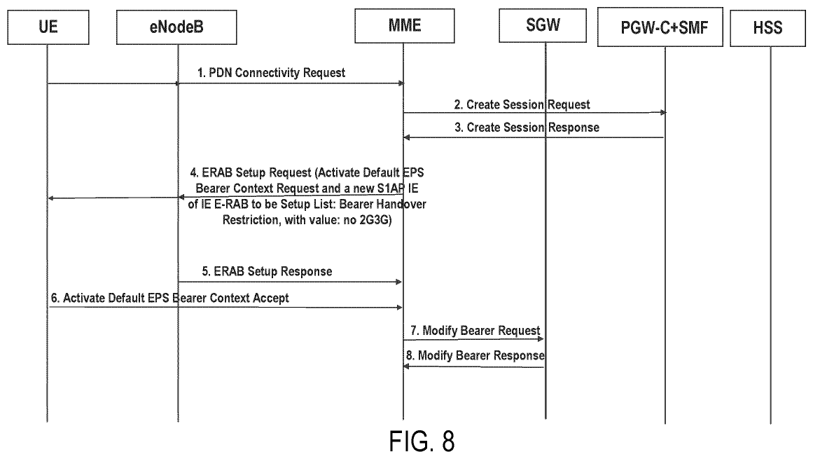

FIG. 8 is a flowchart illustrating an exemplary process according to an embodiment of the disclosure. In this process, the MME notifies the eNodeB during PDN connectivity with PGW-C+SMF about handover restriction of each bearer with an indicator “Bearer Handover Restriction” with value “no 2G3G”. The process may be used for explaining the methods of FIGS. 3 and 6. At step 1, the UE sends a PDN Connectivity Request to the MME. At step 2, the MME sends a Create Session Request to the PGW-C+SMF. At step 3, the PGW-C+SMF sends a Create Session Response to the MME. At step 4, the MME sends, to the UE, an ERAB Setup Request including a new S1AP IE of IE “E-RAB to be Setup List: Bearer Handover Restriction” with value “no 2G3G”. At step 5, the eNodeB sends an ERAB Setup Response to the MME. At step 6, the UE sends an Activate Default EPS Bearer Context Accept to the MME. At step 7, the MME sends a Modify Bearer Request to the SGW. At step 8, the SGW sends a Modify Bearer Response to the MME.

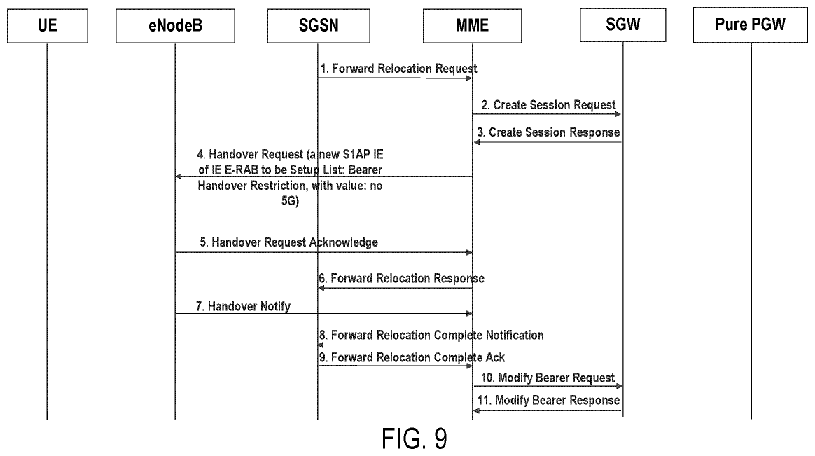

FIG. 9 is a flowchart illustrating an exemplary process according to an embodiment of the disclosure. In this process, the MME notifies the eNodeB during 2/3G-4G handover about handover restriction of each bearer with an indicator “Bearer Handover Restriction” with value “no 5G”. The process may be used for explaining the methods of FIGS. 3 and 6. At step 1, the SGSN sends a Forward Relocation Request to the MME. At step 2, the MME sends a Create Session Request to the SGW. At step 3, the SGW sends a Create Session Response to the MME. At step 4, the MME sends, to the eNodeB, a Handover Request including a new S1AP IE of IE “E-RAB to be Setup List: Bearer Handover Restriction” with value “no 5G”. At step 5, the eNodeB sends a Handover Request Acknowledge to the MME. At step 6, the MME sends a Forward Relocation Response to the SGSN. At step 7, the eNodeB sends a Handover Notify to the MME. At step 8, the MME sends a Forward Relocation Complete Notification to the SGSN. At step 9, the SGSN sends a Forward Relocation Complete Ack to the MME. At step 10, the MME sends a Modify Bearer Request to the SGW. At step 11, the SGW sends a Modify Bearer Response to the MME.

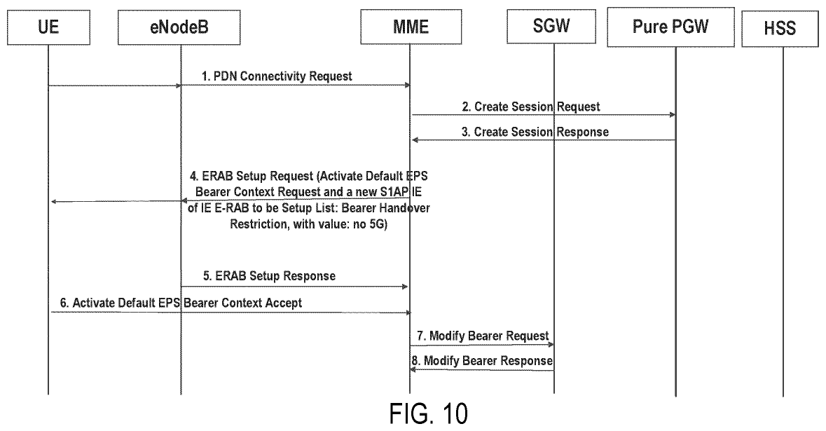

FIG. 10 is a flowchart illustrating an exemplary process according to an embodiment of the disclosure. In this process, the MME notifies the eNodeB during PDN connectivity with pure PGW about handover restriction of each bearer with an indicator “Bearer Handover Restriction” with value “no 5G”. The process may be used for explaining the methods of FIGS. 3 and 6. At step 1, the UE sends a PDN Connectivity Request to the MME. At step 2, the MME sends a Create Session Request to the pure PGW. At step 3, the pure PGW sends a Create Session Response to the MME. At step 4, the MME sends, to the UE, an ERAB Setup Request including a new S1AP IE of IE “E-RAB to be Setup List: Bearer Handover Restriction” with value “no 5G”. At step 5, the eNodeB sends an ERAB Setup Response to the MME. At step 6, the UE sends an Activate Default EPS Bearer Context Accept to the MME. At step 7, the MME sends a Modify Bearer Request to the SGW. At step 8, the SGW sends a Modify Bearer Response to the MME.

According to the above exemplary processes, the following changes are proposed to be made to 3GPP TS 36.413 V15.10.0, where the changes are highlighted with underlines.

### 8.2.1 E-RAB Setup

### 8.2.1.1 General

The purpose of the E-RAB Setup procedure is to assign resources on Uu and S1 for one or several E-RABs and to setup corresponding Data Radio Bearers for a given UE. The procedure uses UE-associated signalling.

### 8.2.1.2 Successful Operation

. . .

If the Bearer Type IE is included in the E-RAB SETUP REQUEST message and is set to “non IP”, then the eNB shall not perform header compression for the concerned E-RAB.

If the Bearer Handover Restriction IE is included in the E-RAB SETUP REQUEST message, then the eNB shall, if supported, store this information and use it when handle the SRVCC or PS handover.

The E-RAB SETUP REQUEST message may contain
the UE Aggregate Maximum Bit Rate IE.

. . .

### 8.3.1 Initial Context Setup

### 8.3.1.1 General

The purpose of the Initial Context Setup procedure is to establish the necessary overall initial UE Context including E-RAB context, the Security Key, Handover Restriction List. UE Radio capability and UE Security Capabilities etc. The procedure uses UE-associated signalling.

### 8.3.1.2 Successful Operation

. . .

The E-RAB to be Setup Item IE may contain:
the NAS-PDU IE.
the Correlation ID IE in case of LIPA operation.
the SIPTO Correlation ID IE in case of SIPTO@LN operation.
the Bearer Type IE.
the Bearer Handover Restriction IE

. . .

If the Bearer Type IE is included in the INITIAL CONTEXT SETUP REQUEST message and is set to “non IP”, then the eNB shall not perform header compression for the concerned E-RAB.

If the Bearer Handover Restriction IE is included in the E-RAB SETUP REQUEST message, then the eNB shall, if supported, store this information and use it when handle the SRVCC or PS handover.

If the Masked IMEISV IE is contained in the INITIAL CONTEXT SETUP REQUEST the target eNB shall, if supported, use it to determine the characteristics of the UE for subsequent handling.

. . .

### 8.4.2 Handover Resource Allocation

### 8.4.2.1 General

The purpose of the Handover Resource Allocation procedure is to reserve resources at the target eNB for the handover of a UE.

### 8.4.2.2 Successful Operation

If the Bearer Type IE is included in the HANDOVER REQUEST message and is set to “non IP”, then the eNB shall not perform header compression for the concerned E-RAB.

If the Bearer Handover Restriction IE is included in the E-RAB SETUP REQUEST message, then the eNB shall, if supported, store this information and use it when handle the SRVCC or PS handover.

After all necessary resources for the admitted E-RABs have been allocated, the target eNB shall generate the HANDOVER REQUEST ACKNOWLEDGE message. The target eNB shall include in the E-RABs Admitted List IE the E-RABs for which resources have been prepared at the target cell. The E-RABs that have not been admitted in the target cell, if any, shall be included in the E-RABs Failed to Setup List IE.

. . .

### 9.1.3.1 E-RAB Setup Request

This message is sent by the MME and is used to request the eNB to assign resources on Uu and S1 for one or several E-RABs.

Direction: MME->eNB

| | | | IE type and | Semantics | | Assigned |
|---|---|---|---|---|---|---|
| IE/Group Name | Presence | Range | reference | description | Criticality | Criticality |
| Message Type | M | | 9.2.1.1 | | YES | Reject |
| MME UE S1AP ID | M | | 9.2.3.3 | | YES | Reject |
| eNB UE S1AP ID | M | | 9.2.3.4 | | YES | Reject |
| UE Aggregate Maximum | O | | 9.2.1.20 | | YES | Reject |
| Bit Rate | | | | | | |
| E-RAB to be Setup List | | 1 | | | YES | Reject |
| >E-RAB To Be Setup | | 1 . . . <maxnoofE- | | | EACH | Reject |
| Item IEs | | RABs> | | | | |
| >>E-RAB ID | M | | 9.2.1.2 | | — | |
| >>E-RAB Level QoS | M | | 9.2.1.15 | Includes | — | |
| Parameters | | | | necessary | | |
| | | | | QoS | | |
| | | | | parameters. | | |
| >>Transport Layer | M | | 9.2.2.1 | | — | |
| Address | | | | | | |
| >>GTP-TEID | M | | 9.2.2.2 | EPC TEID. | — | |
| >>NAS-PDU | M | | 9.2.3.5 | | — | |
| >>Correlation ID | C | | 9.2.1.80 | | YES | Ignore |
| >>SIPTO Correlation ID | O | | Correlation ID | | YES | Ignore |
| | | | 9.2.1.80 | | | |
| >>Bearer Type | O | | 9.2.1.116 | | YES | Reject |
| >>Bearer Handover | O | | 9.2.1.xyz | | YES | Reject |
| Restriction | | | | | | |

### 9.1.4.1 Initial Context Setup Request

This message is sent by the MME to request the setup of a UE context.

Direction: MME->eNB

| | | | IE type and | Semantics | | Assigned |
|---|---|---|---|---|---|---|
| IE/Group Name | Presence | Range | reference | description | Criticality | Criticality |
| Message Type | M | | 9.2.1.1 | | YES | reject |
| MME UE S1AP ID | M | | 9.2.3.3 | | YES | reject |
| eNB UE S1AP ID | M | | 9.2.3.4 | | YES | reject |
| UE Aggregate Maximum | M | | 9.2.1.20 | | YES | reject |
| Bit Rate | | | | | | |
| E-RAB to Be Setup List | | 1 | | | YES | reject |
| >E-RAB to Be Setup | | 1 . . . <maxnoofE- | | | EACH | reject |
| Item IEs | | RABS> | | | | |
| >>E-RAB ID | M | | 9.2.1.2 | | — | |
| >>E-RAB Level QoS | M | | 9.2.1.15 | Includes | — | |
| Parameters | | | | necessary | | |
| | | | | QoS | | |
| | | | | parameters. | | |
| >>Transport Layer | M | | 9.2.2.1 | | — | |
| Address | | | | | | |
| >>GTP-TEID | M | | 9.2.2.2 | | — | |
| >>NAS-PDU | O | | 9.2.3.5 | | — | |
| >>Correlation ID | O | | 9.2.1.80 | | YES | ignore |
| >>SIPTO Correlation | O | | Correlation | | YES | ignore |
| ID | | | ID | | | |
| | | | 9.2.1.80 | | | |
| >>Bearer Type | O | | 9.2.1.116 | | YES | reject |
| >>Bearer Handover | O | | 9.2.1.xyz | | YES | reject |
| Restriction | | | | | | |
| UE Security Capabilities | M | | 9.2.1.40 | | YES | reject |
| Security Key | M | | 9.2.1.41 | The KeNB is | YES | reject |
| | | | | provided | | |
| | | | | after the key- | | |
| | | | | generation in | | |
| | | | | the MME, | | |
| | | | | see TS | | |
| | | | | 33.401 [15]. | | |
| Trace Activation | O | | 9.2.1.4 | | YES | ignore |
| Handover Restriction List | O | | 9.2.1.22 | | YES | ignore |
| UE Radio Capability | O | | 9.2.1.27 | | YES | ignore |
| Subscriber Profile ID for | O | | 9.2.1.39 | | YES | ignore |
| RAT/Frequency priority | | | | | | |
| CS Fallback Indicator | O | | 9.2.3.21 | | YES | reject |
| SRVCC Operation | O | | 9.2.1.58 | | YES | ignore |
| Possible | | | | | | |
| CSG Membership Status | O | | 9.2.1.73 | | YES | ignore |
| Registered LAI | | | 9.2.3.1 | | YES | ignore |
| GUMMEI | O | | 9.2.3.9 | This IE | YES | ignore |
| | | | | indicates the | | |
| | | | | MME serving | | |
| | | | | the UE. | | |
| MME UE S1AP ID 2 | O | | 9.2.3.3 | This IE | YES | ignore |
| | | | | indicates the | | |
| | | | | MME UE | | |
| | | | | S1AP ID | | |
| | | | | assigned by | | |
| | | | | the MME. | | |
| Management Based MDT | O | | 9.2.1.83 | | YES | ignore |
| Allowed | | | | | | |
| Management Based MDT | O | | MDT | | YES | ignore |
| PLMN List | | | PLMN List | | | |
| | | | 9.2.1.89 | | | |
| Additional CS Fallback | C- | | 9.2.3.37 | | YES | ignore |
| Indicator | ifCSFBhighpriority | | | | | |
| Masked IMEISV | O | | 9.2.3.38 | | YES | ignore |
| Expected UE Behaviour | O | | 9.2.1.96 | | YES | ignore |
| ProSe Authorized | O | | 9.2.1.99 | | YES | ignore |
| UE User Plane CIoT | O | | 9.2.1.113 | | YES | ignore |
| Support Indicator | | | | | | |
| V2X Services Authorized | | | 9.2.1.120 | | YES | ignore |
| UE Sidelink Aggregate | O | | 9.2.1.122 | This IE | YES | ignore |
| Maximum Bit Rate | | | | applies only | | |
| | | | | if the UE is | | |
| | | | | authorized | | |
| | | | | for V2X | | |
| | | | | services. | | |
| Enhanced Coverage | O | | 9.2.1.123 | | YES | ignore |
| Restricted | | | | | | |
| NR UE Security | O | | 9.2.1.127 | | YES | ignore |
| Capabilities | | | | | | |
| CE-mode-B Restricted | O | | 9.2.1.129 | | YES | ignore |
| Aerial UE subscription | O | | 9.2.1.136 | | YES | ignore |
| information | | | | | | |
| Pending Data Indication | O | | 9.2.3.55 | | YES | ignore |
| Subscription Based UE | | | 9.2.1.140 | | YES | ignore |
| Differentiation Information | | | | | | |

### 9.1.5.4 Handover Request

This message is sent by the MME to the target eNB to request the preparation of resources.

Direction: MME->eNB.

| | | | IE type | Semantics | | Assigned |
|---|---|---|---|---|---|---|
| IE/Group Name | Presence | Range | and reference | description | Criticality | Criticality |
| Message Type | M | | 9.2.1.1 | | YES | reject |
| MME UE S1AP ID | M | | 9.2.3.3 | | YES | reject |
| Handover Type | M | | 9.2.1.13 | | YES | reject |
| Cause | M | | 9.2.1.3 | | YES | ignore |
| UE Aggregate Maximum Bit | M | | 9.2.1.20 | | YES | reject |
| Rate | | | | | | |
| E-RABs To Be Setup List | | 1 | | | YES | reject |
| >E-RABs To Be Setup | | 1 . . . <maxnoofE- | | | EACH | reject |
| Item IEs | | RABs> | | | | |
| >>E-RAB ID | M | | 9.2.1.2 | | — | |
| >>Transport Layer | M | | 9.2.2.1 | | — | |
| Address | | | | | | |
| >>GTP-TEID | M | | 9.2.2.2 | To deliver UL | — | |
| | | | | PDUs. | | |
| >>E-RAB Level QoS | M | | 9.2.1.15 | Includes | — | |
| Parameters | | | | necessary | | |
| | | | | QoS | | |
| | | | | parameters. | | |
| >>Data Forwarding Not | O | | 9.2.1.76 | | YES | ignore |
| Possible | | | | | | |
| >>Bearer Type | O | | 9.2.1.116 | | YES | reject |
| >>Bearer Handover | O | | 9.2.1.xyz | | YES | reject |
| Restriction | | | | | | |
| Source to Target Transparent | M | | 9.2.1.56 | | YES | reject |
| Container | | | | | | |
| UE Security Capabilities | M | | 9.2.1.40 | | YES | reject |
| Handover Restriction List | O | | 9.2.1.22 | | YES | ignore |
| Trace Activation | O | | 9.2.1.4 | | YES | ignore |
| Request Type | O | | 9.2.1.34 | | YES | ignore |
| SRVCC Operation Possible | O | | 9.2.1.58 | | YES | ignore |
| Security Context | M | | 9.2.1.26 | | YES | reject |
| NAS Security Parameters to | C- | | 9.2.3.31 | The eNB shall | YES | reject |
| E-UTRAN | iffromUTRANGERAN | | | use this IE as | | |
| | | | | specified in TS | | |
| | | | | 33.401 [15]. | | |
| CSG Id | O | | 9.2.1.62 | | YES | reject |
| CSG Membership Status | O | | 9.2.1.73 | | YES | ignore |
| GUMMEI | O | | 9.2.3.9 | This IE | YES | ignore |
| | | | | indicates the | | |
| | | | | MME serving | | |
| | | | | the UE. | | |
| MME UE S1AP ID 2 | O | | 9.2.3.3 | This IE | YES | ignore |
| | | | | indicates the | | |
| | | | | MME UE | | |
| | | | | S1AP ID | | |
| | | | | assigned by | | |
| | | | | the MME. | | |
| Management Based MDT | O | | 9.2.1.83 | | YES | ignore |
| Allowed | | | | | | |
| Management Based MDT | O | | MDT | | YES | ignore |
| PLMN List | | | PLMN List | | | |
| | | | 9.2.1.89 | | | |
| Masked IMEISV | O | | 9.2.3.38 | | YES | ignore |
| Expected UE Behaviour | O | | 9.2.1.96 | | YES | ignore |
| ProSe Authorized | O | | 9.2.1.99 | | YES | ignore |
| UE User Plane CIoT Support | O | | 9.2.1.113 | | YES | ignore |
| Indicator | | | | | | |
| V2X Services Authorized | O | | 9.2.1.120 | | YES | ignore |
| UE Sidelink Aggregate | O | | 9.2.1.122 | This IE applies | YES | ignore |
| Maximum Bit Rate | | | | only if the UE | | |
| | | | | is authorized | | |
| | | | | for V2X | | |
| | | | | services. | | |
| Enhanced Coverage | O | | 9.2.1.123 | | YES | ignore |
| Restricted | | | | | | |
| NR UE Security Capabilities | O | | 9.2.1.127 | | YES | ignore |
| CE-mode-B Restricted | O | | 9.2.1.129 | | YES | ignore |
| Aerial UE subscription | O | | 9.2.1.136 | | YES | ignore |
| information | | | | | | |
| Pending Data Indication | O | | 9.2.3.55 | | YES | ignore |
| Subscription Based UE | O | | 9.2.1.140 | | YES | ignore |
| Differentiation Information | | | | | | |

### 9.2.1.Xyz Bearer Handover Restriction

This IE is used to indicate the E-RAB handover restriction.

| | | | | |
|---|---|---|---|---|
| IE/Group | | | IE type and | Semantics |
| Name | Presence | Range | reference | description |

| | | | |
|---|---|---|---|
| Bearer | O | ENUMERATED | Value “no 2G3G” |
| Handover | | (no 2G3G, no | indicates that |
| Restriction | | 5G, . . . ) | E-RAB cannot be |
| | | | handed over |
| | | | to 2G/3G |
| | | | Value “no 5G” |
| | | | indicates that |
| | | | E-RAB cannot be |
| | | | handed over to 5G |

According to the above exemplary processes, the following changes are proposed to be made to 3GPP TS 36.413 V16.4.0, where the changes are highlighted with underlines.

### 8.2.1 E-RAB Setup

### 8.2.1.1 General

The purpose of the E-RAB Setup procedure is to assign resources on Uu and S1 for one or several E-RABs and to setup corresponding Data Radio Bearers for a given UE. The procedure uses UE-associated signalling.

### 8.2.1.2 Successful Operation

. . .

If the Ethernet Type IE is included in the E-RAB SETUP REQUEST message and is set to “True”, then the eNB shall, if supported, take this into account to perform header compression appropriately for the concerned E-RAB.

If the Bearer Handover Restriction IE is included in the E-RAB SETUP REQUEST message, then the eNB shall, if supported, store this information and use it when handle the SRVCC or PS handover.

The E-RAB SETUP REQUEST message may contain
the UE Aggregate Maximum Bit Rate IE.

### 8.3.1 Initial Context Setup

### 8.3.1.1 General

The purpose of the Initial Context Setup procedure is to establish the necessary overall initial UE Context including E-RAB context, the Security Key. Handover Restriction List. UE Radio capability and UE Security Capabilities etc. The procedure uses UE-associated signalling.

### 8.3.1.2 Successful Operation

. . .

The E-RAB to be Setup Item IE may contain:
the NAS-PDU IE.
the Correlation ID IE in case of LIPA operation.
the SIPTO Correlation ID IE in case of SIPTO@LN operation.
the Bearer Type IE.
the Bearer Handover Restriction IE

. . .

If the Ethernet Type IE is included in the INITIAL CONTEXT SETUP REQUEST message and is set to “True”, then the eNB shall, if supported, take this into account to perform header compression appropriately for the concerned E-RAB.

If the Bearer Handover Restriction IE is included in the E-RAB SETUP REQUEST message, then the eNB shall, if supported, store this information and use it when handle the SRVCC or PS handover.

If the Masked IMEISV IE is contained in the INITIAL CONTEXT SETUP REQUEST the target eNB shall, if supported, use it to determine the characteristics of the UE for subsequent handling.

### 8.4.2 Handover Resource Allocation

### 8.4.2.1 General

The purpose of the Handover Resource Allocation procedure is to reserve resources at the target eNB for the handover of a UE.

### 8.4.2.2 Successful Operation

. . .

If the Expected UE Behaviour IE is included in the HANDOVER REQUEST message, the eNB shall, if supported, store this information and may use it to determine the RRC connection time.

If the Bearer Handover Restriction IE is included in the E-RAB SETUP REQUEST message, then the eNB shall, if supported, store this information and use it when handle the SRVCC or PS handover.

After all necessary resources for the admitted E-RABs have been allocated, the target eNB shall generate the HANDOVER REQUEST ACKNOWLEDGE message. The target eNB shall include in the E-RABs Admitted List IE the E-RABs for which resources have been prepared at the target cell. The E-RABs that have not been admitted in the target cell, if any, shall be included in the E-RABs Failed to Setup List IE.

### 9.1.3.1 E-RAB SETUP REQUEST

This message is sent by the MME and is used to request the eNB to assign resources on Uu and S1 for one or several E-RABs.

Direction: MME->eNB

| | | | IE type and | Semantics | | Assigned |
|---|---|---|---|---|---|---|
| IE/Group Name | Presence | Range | reference | description | Criticality | Criticality |
| Message Type | M | | 9.2.1.1 | | YES | reject |
| MME UE S1AP ID | M | | 9.2.3.3 | | YES | reject |
| eNB UE S1AP ID | M | | 9.2.3.4 | | YES | reject |
| UE Aggregate Maximum | O | | 9.2.1.20 | | YES | reject |
| Bit Rate | | | | | | |
| E-RAB to be Setup List | | 1 | | | YES | reject |
| >E-RAB To Be Setup | | 1 . . . <maxnoofE- | | | EACH | reject |
| Item IEs | | RABs> | | | | |
| >>E-RAB ID | M | | 9.2.1.2 | | — | |
| >>E-RAB Level QoS | M | | 9.2.1.15 | Includes | — | |
| Parameters | | | | necessary | | |
| | | | | QoS | | |
| | | | | parameters. | | |
| >>Transport Layer | M | | 9.2.2.1 | | — | |
| Address | | | | | | |
| >>GTP-TEID | M | | 9.2.2.2 | EPC TEID. | — | |
| >>NAS-PDU | M | | 9.2.3.5 | | — | |
| >>Correlation ID | O | | 9.2.1.80 | | YES | ignore |
| >>SIPTO Correlation ID | O | | Correlation | | YES | ignore |
| | | | ID | | | |
| | | | 9.2.1.80 | | | |
| >>Bearer Type | O | | 9.2.1.116 | | YES | reject |
| >>Ethernet Type | O | | 9.2.1.147 | | YES | ignore |
| >>Bearer Handover | O | | 9.2.1.xyz | | YES | ignore |
| Restriction | | | | | | |

### 9.1.4.1 Initial Context Setup Request

This message is sent by the MME to request the setup of a UE context.

Direction: MME->eNB

| | | | IE type and | Semantics | | Assigned |
|---|---|---|---|---|---|---|
| IE/Group Name | Presence | Range | reference | description | Criticality | Criticality |
| Message Type | M | | 9.2.1.1 | | YES | reject |
| MME UE S1AP ID | M | | 9.2.3.3 | | YES | reject |
| eNB UE S1AP ID | M | | 9.2.3.4 | | YES | reject |
| UE Aggregate Maximum | M | | 9.2.1.20 | | YES | reject |
| Bit Rate | | | | | | |
| E-RAB to Be Setup List | | 1 | | | YES | reject |
| >E-RAB to Be Setup | | 1 . . . <maxnoofE- | | | EACH | reject |
| Item IEs | | RABs> | | | | |
| >>E-RAB ID | M | | 9.2.1.2 | | — | |
| >>E-RAB Level QoS | M | | 9.2.1.15 | Includes | — | |
| Parameters | | | | necessary | | |
| | | | | QoS | | |
| | | | | parameters. | | |
| >>Transport Layer | M | | 9.2.2.1 | | — | |
| Address | | | | | | |
| >>GTP-TEID | M | | 9.2.2.2 | | — | |
| >>NAS-PDU | O | | 9.2.3.5 | | — | |
| >>Correlation ID | O | | 9.2.1.80 | | YES | ignore |
| >>SIPTO Correlation | O | | Correlation | | YES | ignore |
| ID | | | ID | | | |
| | | | 9.2.1.80 | | | |
| >>Bearer Type | O | | 9.2.1.116 | | YES | reject |
| >>Ethernet Type | O | | 9.2.1.147 | | YES | ignore |
| >>Bearer Handover | O | | 9.2.1.xyz | | YES | ignore |
| Restriction | | | | | | |
| UE Security Capabilities | M | | 9.2.1.40 | | YES | reject |
| Security Key | M | | 9.2.1.41 | The KeNB is | YES | reject |
| | | | | provided | | |
| | | | | after the key- | | |
| | | | | generation in | | |
| | | | | the MME, | | |
| | | | | see TS | | |
| | | | | 33.401 [15]. | | |
| Trace Activation | O | | 9.2.1.4 | | YES | ignore |
| Handover Restriction List | O | | 9.2.1.22 | | YES | ignore |
| UE Radio Capability | O | | 9.2.1.27 | | YES | ignore |
| Subscriber Profile ID for | O | | 9.2.1.39 | | YES | ignore |
| RAT/Frequency priority | | | | | | |
| CS Fallback Indicator | O | | 9.2.3.21 | | YES | reject |
| SRVCC Operation | O | | 9.2.1.58 | | YES | ignore |
| Possible | | | | | | |
| CSG Membership Status | O | | 9.2.1.73 | | YES | ignore |
| Registered LAI | O | | 9.2.3.1 | | YES | ignore |
| GUMMEI | O | | 9.2.3.9 | This IE | YES | ignore |
| | | | | indicates the | | |
| | | | | MME serving | | |
| | | | | the UE. | | |
| MME UE S1AP ID 2 | O | | 9.2.3.3 | This IE | YES | ignore |
| | | | | indicates the | | |
| | | | | MME UE | | |
| | | | | S1AP ID | | |
| | | | | assigned by | | |
| | | | | the MME. | | |
| Management Based MDT | O | | 9.2.1.83 | | YES | ignore |
| Allowed | | | | | | |
| Management Based MDT | O | | MDT PLMN | | YES | ignore |
| PLMN List | | | List | | | |
| | | | 9.2.1.89 | | | |
| Additional CS Fallback | C- | | 9.2.3.37 | | YES | ignore |
| Indicator | ifCSFBhighpriority | | | | | |
| Masked IMEISV | O | | 9.2.3.38 | | YES | ignore |
| Expected UE Behaviour | O | | 9.2.1.96 | | YES | ignore |
| ProSe Authorized | O | | 9.2.1.99 | | YES | ignore |
| UE User Plane CIoT | O | | 9.2.1.113 | | YES | ignore |
| Support Indicator | | | | | | |
| V2X Services Authorized | O | | 9.2.1.120 | | YES | ignore |
| UE Sidelink Aggregate | O | | 9.2.1.122 | This IE | YES | ignore |
| Maximum Bit Rate | | | | applies only | | |
| | | | | if the UE is | | |
| | | | | authorized | | |
| | | | | for V2X | | |
| | | | | services. | | |
| Enhanced Coverage | O | | 9.2.1.123 | | YES | ignore |
| Restricted | | | | | | |
| NR UE Security | O | | 9.2.1.127 | | YES | ignore |
| Capabilities | | | | | | |
| CE-mode-B Restricted | O | | 9.2.1.129 | | YES | ignore |
| Aerial UE subscription | O | | 9.2.1.136 | | YES | ignore |
| information | | | | | | |
| Pending Data Indication | O | | 9.2.3.55 | | YES | ignore |
| Subscription Based UE | O | | 9.2.1.140 | | YES | ignore |
| Differentiation Information | | | | | | |
| Additional RRM Policy | O | | 9.2.1.39a | | YES | ignore |
| Index | | | | | | |
| IAB Authorized | O | | 9.2.1.146 | | YES | ignore |
| NR V2X Services | O | | 9.2.1.148 | | YES | ignore |
| Authorized | | | | | | |
| NR UE Sidelink Aggregate | O | | 9.2.1.149 | This IE | YES | ignore |
| Maximum Bit Rate | | | | applies only | | |
| | | | | if the UE is | | |
| | | | | authorized | | |
| | | | | for NR V2X | | |
| | | | | services. | | |
| PC5 QoS Parameters | O | | 9.2.1.150 | This IE | YES | ignore |
| | | | | applies only | | |
| | | | | if the UE is | | |
| | | | | authorized | | |
| | | | | for NR V2X | | |
| | | | | services. | | |
| UE Radio Capability ID | O | | 9.2.1.153 | | YES | reject |

### 9.1.5.4 Handover Request

This message is sent by the MME to the target eNB to request the preparation of resources.

Direction: MME->eNB.

| | | | IE type | Semantics | | Assigned |
|---|---|---|---|---|---|---|
| IE/Group Name | Presence | Range | and reference | description | Criticality | Criticality |
| Message Type | M | | 9.2.1.1 | | YES | reject |
| MME UE S1AP ID | M | | 9.2.3.3 | | YES | reject |
| Handover Type | M | | 9.2.1.13 | | YES | reject |
| Cause | M | | 9.2.1.3 | | YES | ignore |
| UE Aggregate Maximum Bit | M | | 9.2.1.20 | | YES | reject |
| Rate | | | | | | |
| E-RABs To Be Setup List | | 1 | | | YES | reject |
| >E-RABs To Be Setup | | 1 . . . <maxnoofE- | | | EACH | reject |
| Item IEs | | RABs> | | | | |
| >>E-RAB ID | M | | 9.2.1.2 | | — | |
| >>Transport Layer | M | | 9.2.2.1 | | — | |
| Address | | | | | | |
| >>GTP-TEID | M | | 9.2.2.2 | To deliver UL | — | |
| | | | | PDUs. | | |
| >>E-RAB Level QoS | M | | 9.2.1.15 | Includes | — | |
| Parameters | | | | necessary | | |
| | | | | QoS | | |
| | | | | parameters. | | |
| >>Data Forwarding Not | O | | 9.2.1.76 | | YES | ignore |
| Possible | | | | | | |
| >>Bearer Type | O | | 9.2.1.116 | | YES | reject |
| >>Ethernet Type | O | | 9.2.1.147 | | YES | ignore |
| >>Bearer Handover | O | | 9.2.1.xyz | | YES | ignore |
| Restriction | | | | | | |
| Source to Target Transparent | M | | 9.2.1.56 | | YES | reject |
| Container | | | | | | |
| UE Security Capabilities | M | | 9.2.1.40 | | YES | reject |
| Handover Restriction List | O | | 9.2.1.22 | | YES | ignore |
| Trace Activation | O | | 9.2.1.4 | | YES | ignore |
| Request Type | O | | 9.2.1.34 | | YES | ignore |
| SRVCC Operation Possible | O | | 9.2.1.58 | | YES | ignore |
| Security Context | M | | 9.2.1.26 | | YES | reject |
| NAS Security Parameters to | C- | | 9.2.3.31 | The eNB shall | YES | reject |
| E-UTRAN | iffromUTRANGERAN | | | use this IE as | | |
| | | | | specified in TS | | |
| | | | | 33.401 [15]. | | |
| CSG Id | O | | 9.2.1.62 | | YES | reject |
| CSG Membership Status | O | | 9.2.1.73 | | YES | ignore |
| GUMMEI | O | | 9.2.3.9 | This IE | YES | ignore |
| | | | | indicates the | | |
| | | | | MME serving | | |
| | | | | the UE | | |
| MME UE S1AP ID 2 | O | | 9.2.3.3 | This IE | YES | ignore |
| | | | | indicates the | | |
| | | | | MME UE | | |
| | | | | S1AP ID | | |
| | | | | assigned by | | |
| | | | | the MME. | | |
| Management Based MDT | O | | 9.2.1.83 | | YES | ignore |
| Allowed | | | | | | |
| Management Based MDT | O | | MDT | | YES | ignore |
| PLMN List | | | PLMN List | | | |
| | | | 9.2.1.89 | | | |
| Masked IMEISV | O | | 9.2.3.38 | | YES | ignore |
| Expected UE Behaviour | O | | 9.2.1.96 | | YES | ignore |
| ProSe Authorized | O | | 9.2.1.99 | | YES | ignore |
| UE User Plane CIoT Support | | | 9.2.1.113 | | YES | ignore |
| Indicator | | | | | | |
| V2X Services Authorized | | | 9.2.1.120 | | YES | ignore |
| UE Sidelink Aggregate | O | | 9.2.1.122 | This IE applies | YES | ignore |
| Maximum Bit Rate | | | | only if the UE | | |
| | | | | is authorized | | |
| | | | | for V2X | | |
| | | | | services. | | |
| Enhanced Coverage | O | | 9.2.1.123 | | YES | ignore |
| Restricted | | | | | | |
| NR UE Security Capabilities | O | | 9.2.1.127 | | YES | ignore |
| CE-mode-B Restricted | O | | 9.2.1.129 | | YES | ignore |
| Aerial UE subscription | O | | 9.2.1.136 | | YES | ignore |
| information | | | | | | |
| Pending Data Indication | O | | 9.2.3.55 | | YES | ignore |
| Subscription Based UE | O | | 9.2.1.140 | | YES | ignore |
| Differentiation Information | | | | | | |
| Additional RRM Policy Index | O | | 9.2.1.39a | | YES | ignore |
| IAB Authorized | O | | 9.2.1.146 | | YES | reject |
| NR V2X Services Authorized | O | | 9.2.1.148 | | YES | ignore |
| NR UE Sidelink Aggregate | O | | 9.2.1.149 | This IE applies | YES | ignore |
| Maximum Bit Rate | | | | only if the UE | | |
| | | | | is authorized | | |
| | | | | for NR V2X | | |
| | | | | services. | | |
| PC5 QoS Parameters | O | | 9.2.1.150 | This IE applies | YES | ignore |
| | | | | only if the UE | | |
| | | | | is authorized | | |
| | | | | for NR V2X | | |
| | | | | services. | | |
| UE Radio Capability ID | O | | 9.2.1.153 | | YES | reject |

### 9.2.1.Xyz Bearer Handover Restriction

This IE is used to indicate the E-RAB handover restriction.

| | | | | |
|---|---|---|---|---|
| IE/Group | | | IE type and | Semantics |
| Name | Presence | Range | reference | description |

| | | | |
|---|---|---|---|
| Bearer | O | ENUMERATED | Value “no 2G3G” |
| Handover | | (no 2G3G, no | indicates that |
| Restriction | | 5G, . . . ) | E-RAB cannot be |
| | | | handed over |
| | | | to 2G/3G |
| | | | Value “no 5G” |
| | | | indicates that |
| | | | E-RAB cannot be |
| | | | handed over to 5G |

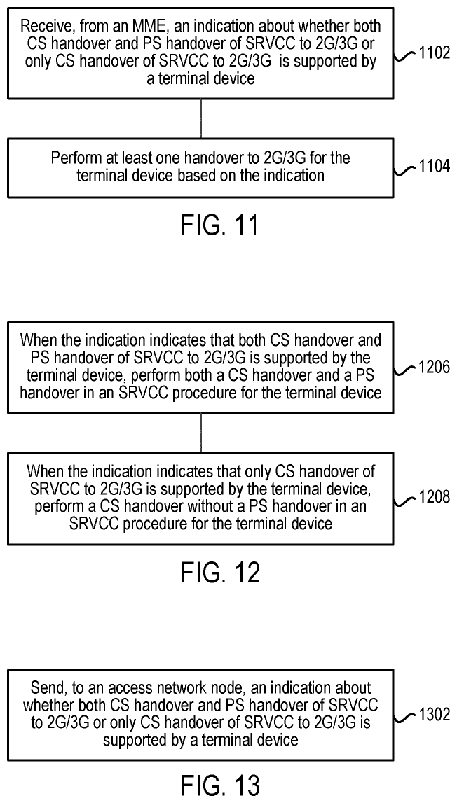

FIG. 11 is a flowchart illustrating a method performed by an access network node according to an embodiment of the disclosure. For example, the access network node may be an eNB. At block 1102, the access network node receives, from an MME, an indication about whether both CS handover and PS handover of SRVCC to 2G/3G or only CS handover of SRVCC to 2G/3G is supported by a terminal device. The CS handover of SRVCC may also be referred to as an IMS voice call handover. For example, the indication may be received in response to one of: the support by the terminal device for both CS handover and PS handover of SRVCC to 2G/3G or only CS handover of SRVCC to 2G/3G is changed; the terminal device turns from idle state to connected state; a serving access network node of the terminal device is changed from another access network node to the access network node; and a serving RAN of the terminal device is changed from a 5G RAN to an LTE RAN. As an exemplary example, the indication may be received in one of: a Downlink NAS Transport message; an E-RAB Setup Request; an Initial Context Setup Request; a Handover Request; a Path Switch Request Acknowledge message; an E-RAB Release Command; and a UE Context Modification Request.

At block 1104, the access network node performs at least one handover to 2G/3G for the terminal device based on the indication. For example, block 1104 may be implemented as including at least one of blocks 1206-1208 of FIG. 12. At block 1206, when the indication indicates that both CS handover and PS handover of SRVCC to 2G/3G is supported by the terminal device, the access network node performs both a CS handover and a PS handover in an SRVCC procedure for the terminal device. At block 1208, when the indication indicates that only CS handover of SRVCC to 2G/3G is supported by the terminal device, the access network node performs a CS handover without a PS handover in an SRVCC procedure for the terminal device. With the method of FIG. 11, it is possible to avoid a failure of an SRVCC procedure to 2G/3G so as to improve the end user experience especially for voice service.

FIG. 13 is a flowchart illustrating a method performed by an MME according to an embodiment of the disclosure. At block 1302, the MME sends, to an access network node, an indication about whether both CS handover and PS handover of SRVCC to 2G/3G or only CS handover of SRVCC to 2G/3G is supported by a terminal device. The CS handover of SRVCC may also be referred to as an IMS voice call handover. For example, the indication may be received in response to one of: the support by the terminal device for both CS handover and PS handover of SRVCC to 2G/3G or only CS handover of SRVCC to 2G/3G is changed; the terminal device turns from idle state to connected state; a serving access network node of the terminal device is changed from another access network node to the access network node; and a serving RAN of the terminal device is changed from a 5G RAN to an LTE RAN. As an exemplary example, the indication may be received in one of: a Downlink NAS Transport message; an E-RAB Setup Request; an Initial Context Setup Request; a Handover Request; a Path Switch Request Acknowledge message; an E-RAB Release Command; and a UE Context Modification Request.

The indication may be determined by the MME as below. For example, if at least one of one or more bearers for the terminal device can be handed over to 2G/3G, the MME may determine that both CS handover and PS handover of SRVCC to 2G/3G is supported by the terminal device when. If none of the one or more bearers for the terminal device can be handed over to 2G/3G, the MME may determine that only CS handover of SRVCC to 2G/3G is supported by the terminal device. With the method of FIG. 13, it is possible to avoid a failure of an SRVCC procedure to 2G/3G so as to improve the end user experience especially for voice service.

As an exemplary example for the methods of FIGS. 11 and 13, changes are made on both an MME and an eNodeB by the MME signaling to the eNB if the PS handover to 2/3G can be supported or not, so as to initiate SRVCC without PS handover if none of the non-voice bearers can move to 2/3G, in order to make voice service not interrupted when a UE moves from LTE to 2/3G. Specifically, if the MME finds that none of the non-voice bearers can move to 2/3G, the MME may send one indication to the eNodeB in subsequent S1 message, to let the eNodeB know “SRVCC with PS handover not supported” in the MME. Then later the eNodeB will initiate SRVCC without PS handover and succeed. And these non-voice bearers will be moved to 2/3G in RAU procedure and released after RAU complete. If some non-voice bearer can be moved to 2/3G, the MME may update the indication as “SRVCC with PS handover supported” and send it to the eNodeB in subsequent S1 message. Then later the eNodeB will initiate SRVCC with PS handover and succeed. And newly activated non-voice bearer together with the voice bearer will be handed over to 2/3G and other non-voice bearers will be deactivated in 2/3G after the PS handover.

Note that because the eNodeB does not save UE context when UE turns to idle state, the MME needs to resend the new SRVCC indication with same content to the eNodeB when UE comes back to connected state. And if the eNodeB is changed for this UE, the MME needs to resend the new indication to the new eNodeB.

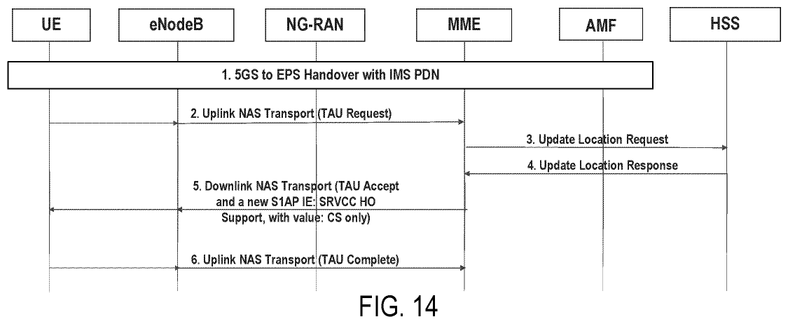

FIG. 14 is a flowchart illustrating an exemplary process according to an embodiment of the disclosure. In this process, the MME notifies the eNodeB with an indicator indicating that SRVCC+PS handover is not supported. The process may be used for explaining the methods of FIGS. 11 and 13. At step 1, the UE has an IMS PDN with a voice bearer and may have other PDNs, and then hands over from 5GS to LTE. All the non-voice bearers are not allocated with TIs and also cannot move to 2/3G. At step 2, after Handover is finished, the UE initiates a TAU request message to the MME. At step 3, the MME sends an Update Location Request to the HSS. At step 4, the HSS sends an Update Location Response to the MME. If getting the UE's SRVCC related subscription from the HSS in the Update Location Response, the MME sends, at step 5, a new S1AP IE “SRVCC HO Support” whose value is “CS only”, to the eNodeB in a Downlink NAS Transport message, when SRVCC is possible to perform. This message also contains NAS part “TAU Accept” to the UE. At step 6, the UE responds with a TAU Complete to the MME.

Then, when the eNodeB decides to initiate a SRVCC procedure to 2/3G, it will trigger SRVCC without PS handover according to the new IE received from the MME before. This SRVCC without PS handover procedure will be successful. The voice call will continue after the UE moves to 2/3G.

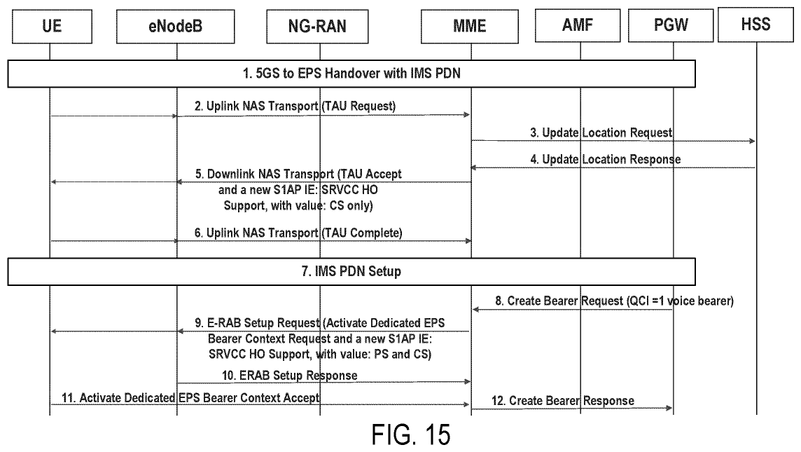

FIG. 15 is a flowchart illustrating an exemplary process according to an embodiment of the disclosure. In this process, the MME notifies the eNodeB with an indicator indicating that SRVCC+PS handover is supported. The process may be used for explaining the methods of FIGS. 11 and 13. At step 1, the UE does not have an IMS PDN including a voice bearer but has other PDNs and then hands over from 5GS to LTE. All the non-voice bearers are not allocated with TIs and also cannot move to 2/3G. At step 2, after Handover is finished, the UE initiates a TAU request message to the MME. At step 3, the MME sends an Update Location Request to the HSS. At step 4, the HSS sends an Update Location Response to the MME. If getting the UE's SRVCC related subscription from the HSS in the Update Location Response, the MME sends, at step 5, a new S1AP IE “SRVCC HO Support” whose value is “CS only” to the eNodeB in a Downlink NAS Transport message. This message also contains NAS part “TAU Accept” to the UE. At step 6, the UE responds with a TAU Complete to the MME.

At step 7, the UE sets up an IMS PDN in LTE, which has a default bearer with a TI allocated by a pure PGW and can move to 2/3G. At step 8, a dedicated bearer with QoS class identifier (QCI)=1 is created for a voice call over IMS PDN. At step 9, the MME updates the new S1AP IE “SRVCC HO Support” with a changed value “PS and CS” in an ERAB Setup Request to the eNodeB, because part of the non-voice bearers (IMS PDN default bearer) can move to 2/3G, and SRVCC with PS Handover can be successful. Note that this IE with a changed value can also be sent in the previous ERAB Setup Request for IMS PDN setup at step 7. That is, as long as a PS handover is possible, the value of the new IE can be changed. At step 10, the eNodeB sends an ERAB Setup Response to the MME. At step 11, the UE sends an Activate Dedicated EPS Bearer Context Accept to the MME. At step 12, the MME sends a Create Bearer Response to the PGW.

Then, after notified by the new IE and the voice bearer setup, when the UE moves to 2/3G, the eNodeB will decide to trigger SRVCC with PS handover. This SRVCC with PS handover procedure will be successful. The voice bearer and IMS PDN default bearer will move to 2/3G. The voice call will continue after the UE moves to 2/3G.

Note that the new IE “SRVCC HO Support” can be sent in other S1AP messages, such as Initial Context Setup Request, Handover Request, Path Switch Request Acknowledge, ERAB Release Command and UE CONTEXT MODIFICATION REQUEST. The new IE “SRVCC HO Support” may be sent: when the MME finds “SRVCC with PS HO support” value is changed due to bearers activation/deactivation, or when the UE turns from idle to connected, or when the UE moves from one eNodeB to another eNodeB or from 5G to LTE, or the like.

According to the above exemplary processes, the following changes are proposed to be made to 3GPP TS 36.413, where the changes are highlighted with underlines. Note that other S1AP messages, including Initial Context Setup Request, Path Switch Request Acknowledge, Handover Request, ERAB Release Command and UE Context Modification Request can also include this new IE.

TABLE 1
Downlink NAS Transport

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | | 9.2.1.1 | YES | ignore |
| MME UE S1AP | M | | 9.2.3.3 | YES | reject |
| ID | | | | | |
| eNB UE S1AP ID | M | | 9.2.3.4 | YES | reject |
| NAS-PDU | M | | 9.2.3.5 | YES | reject |
| Handover | O | | 9.2.1.22 | YES | ignore |
| Restriction List | | | | | |
| Subscriber Profile | O | | 9.2.1.39 | YES | ignore |
| ID for | | | | | |
| RAT/Frequency | | | | | |
| priority | | | | | |
| . . . | | | | | |
| SRVCC HO | C | PS and CS or | | YES | ignore |
| Support | | CS only; | | | |
| | | Note: it is only | | | |
| | | valid when IE | | | |
| | | “SRVCC | | | |
| | | Operation | | | |
| | | Possible” with | | | |
| | | value “possible” | | | |
| | | is present | | | |

TABLE 2
ERAB Setup Request

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | | 9.2.1.1 | YES | reject |
| MME UE S1AP | M | | 9.2.3.3 | YES | reject |
| ID | | | | | |
| eNB UE S1AP | M | | 9.2.3.4 | YES | reject |
| ID | | | | | |
| UE Aggregate | | | 9.2.1.20 | YES | reject |
| Maximum Bit | | | | | |
| Rate | | | | | |
| . . . | | | | | |
| SRVCC HO | O | PS and CS | | YES | ignore |
| Support | | or CS only | | | |

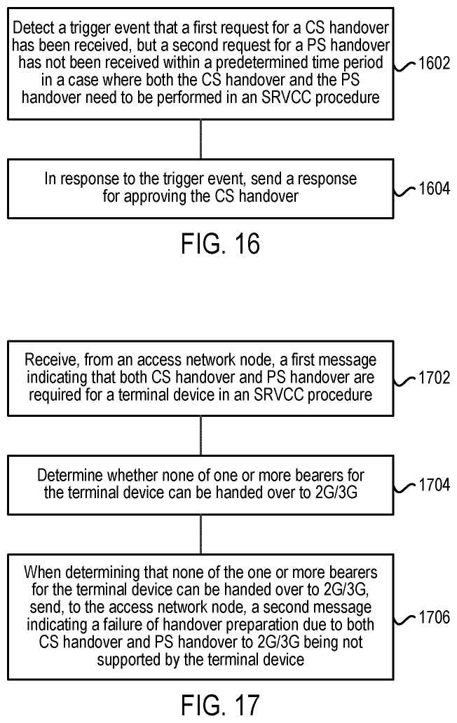

FIG. 16 is a flowchart illustrating a method performed by an access network node according to an embodiment of the disclosure. For example, the access network node may be an RNC. At block 1602, the access network node detects a trigger event that a first request for a CS handover has been received, but a second request for a PS handover has not been received within a predetermined time period in a case where both the CS handover and the PS handover need to be performed in an SRVCC procedure. For example, the first request may be an Relocation/Handover Request from a target MSC and the second request may be an Relocation/Handover Request from a target SGSN. At block 1604, in response to the trigger event, the access network node sends a response for approving the CS handover. With the method of FIG. 16, because the response for approving the CS handover is sent even if the second request is not received, it is possible to avoid a failure of an SRVCC procedure to 2G/3G so as to improve the end user experience especially for voice service.

As an exemplary example for the method of FIG. 16, the RNC may accept the CS SRVCC when the PS Handover Request does not arrive. In other words, the target RNC makes the SRVCC procedure successful when the PS RAN handover is not received. Specifically, the following clarification is proposed to be added into 3GPP TS 25.413: “the target RNC considers the CS handover in SRVCC procedure as successful in the case of both PS and CS handover in SRVCC, when the PS handover request (step 6b in FIG. 2) is never received after a waiting timer expires”. This solution may cause latency to handle CS SRVCC procedure due to the waiting for the timer.

According to the above exemplary example, the following changes are proposed to be made to 3GPP TS 25.413, where the changes are highlighted with underlines.

### 8.7.5 Co-Ordination of Two Iu Signalling Connections

In case the SRVCC operation is performed and the source system is E-UTRAN, the target RNC shall generate and send RELOCATION REQUEST ACKNOWLEDGE message to the CN in CS domain if the relocation of SRNS is accepted for the CS domain but not accepted for the PS domain or the Relocation Request is not received from SGSN.

FIG. 17 is a flowchart illustrating a method performed by an MME according to an embodiment of the disclosure. At block 1702, the MME receives, from an access network node, a first message indicating that both CS handover and PS handover are required for a terminal device in an SRVCC procedure. For example, the access network node may be an eNB and the first message may be a Handover Required message having an IE “SRVCC HO Indication” with value “PS and CS”. At block 1704, the MME determines whether none of one or more bearers for the terminal device can be handed over to 2G/3G. As an example, if a bearer for the terminal device is established in LTE and capable of interworking with 5GS, the MME may determine that the bearer cannot be handed over to 2G/3G. As another example, if a bearer for the terminal device is handed over from 5G to LTE, the MME may determine that the bearer cannot be handed over to 2G/3G. At block 1706, when determining that none of the one or more bearers for the terminal device can be handed over to 2G/3G, the MME sends, to the access network node, a second message indicating a failure of handover preparation due to both CS handover and PS handover to 2G/3G being not supported by the terminal device. For example, the failure of handover preparation due to both CS handover and PS handover to 2G/3G being not supported by the terminal device may be indicated by a failure cause and/or an indication bit. With the method of FIG. 17, it is possible to avoid a long latency for an SRVCC procedure since the failure and its cause are indicated to the access network node as soon as they are detected.

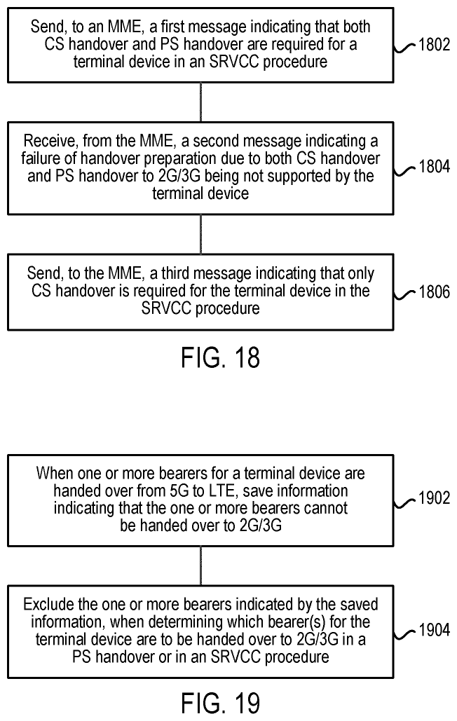

FIG. 18 is a flowchart illustrating a method performed by an access network node according to an embodiment of the disclosure. For example, the access network node may be an eNB. At block 1802, the access network node sends, to an MME, a first message indicating that both CS handover and PS handover are required for a terminal device in an SRVCC procedure. For example, the first message may be a Handover Required message having an IE “SRVCC HO Indication” with value “PS and CS”. At block 1804, the access network node receives, from the MME, a second message indicating a failure of handover preparation due to both CS handover and PS handover to 2G/3G being not supported by the terminal device. For example, the failure of handover preparation due to both CS handover and PS handover to 2G/3G being not supported by the terminal device may be indicated by a failure cause and/or an indication bit. At block 1806, the access network node sends, to the MME, a third message indicating that only CS handover is required for the terminal device in the SRVCC procedure. For example, the third message may be a Handover Required message having an IE “SRVCC HO Indication” with value “CS Only”. With the method of FIG. 18, it is possible to avoid a long latency for an SRVCC procedure so as to improve the end user experience especially for voice service.

As an exemplary example for the methods of FIGS. 17 and 18, the MME may indicate failure for PS Handover to 2/3G and the cause indication to the eNB, so that the eNB could retry SRVCC without PS HO. In other words, this solution is to let the MME to fail and indicate to the eNB when the PS bearer(s) cannot be handover over, so that the eNB could retry SRVCC with CS only. Specifically, when the MME receives a Handover Required message from the eNB with “PS and CS” in SRVCC, but the MME could not hand over all the non-voice PS RABs, the MME shall reply to the eNB with a new failure indication and the failed cause in Handover Preparation Failure to the eNB. The eNB could retry SRVCC with CS only.

According to the above exemplary examples, the following changes are proposed to be made to 3GPP TS 36.413, where the changes are highlighted with underlines. The below table shows an example for MME to indicate to eNB that the PS handover does not work in SRVCC with both CS and PS.

TABLE 5
Handover Preparation Failure

| | | | | | | |
|---|---|---|---|---|---|---|
| | | | IE type and | | | |
| IE/Group Name | Presence | Range | reference | Semantics description | Criticality | Assigned Criticality |

| | | | | | |
|---|---|---|---|---|---|
| Message Type | M | | 9.2.1.1 | YES | reject |
| MME UE S1AP ID | M | | 9.2.3.3 | YES | ignore |
| eNB UE S1AP ID | M | | 9.2.3.4 | YES | ignore |
| Cause | M | With newcause: Not | 9.2.1.3 | YES | ignore |
| | | supported SRVCC type | | | |
| Criticality Diagnostics | O | | 9.2.1.21 | YES | ignore |
| SRVCC HO Unsupported | O | ENUMERATED (true, . . .) | | YES | ignore |
| Indication | | | | | |

FIG. 19 is a flowchart illustrating a method performed by an access network node according to an embodiment of the disclosure. For example, the access network node may be an eNB. At block 1902, when one or more bearers for a terminal device are handed over from 5G to LTE, the access network node saves information indicating that the one or more bearers cannot be handed over to 2G/3G. At block 1904, the access network node excludes the one or more bearers indicated by the saved information, when determining which bearer(s) for the terminal device are to be handed over to 2G/3G in a PS handover or in an SRVCC procedure. With the method of FIG. 19, it is possible to avoid a failure of an SRVCC procedure to 2G/3G so as to improve the end user experience especially for voice service.

As an exemplary example for the method of FIG. 19, the eNB may remember that the E-RABs were handed over from 5GS. For example, it may be specified that after the inter system handover from 5G to 4G, the eNB should remember and mark the E-RABs which cannot handover to 2/3G. When there is a later SRVCC or PS handover to 2/3G, the eNB shall not include these E-RABs in the SRVCC or PS handover.

One possible issue with this solution is that the eNB may not remember which E-RABs cannot handover to 2/3G after UE enters to idle in LTE. So in later SRVCC or PS handover, the eNB cannot select the right E-RABs to perform handover. And for PDN setup in LTE with a PDU session ID and 5G QOS, the eNB does not get known that it cannot move to 2/3G. So in later SRVCC or PS handover, the eNB may select this wrong PDN to perform handover.

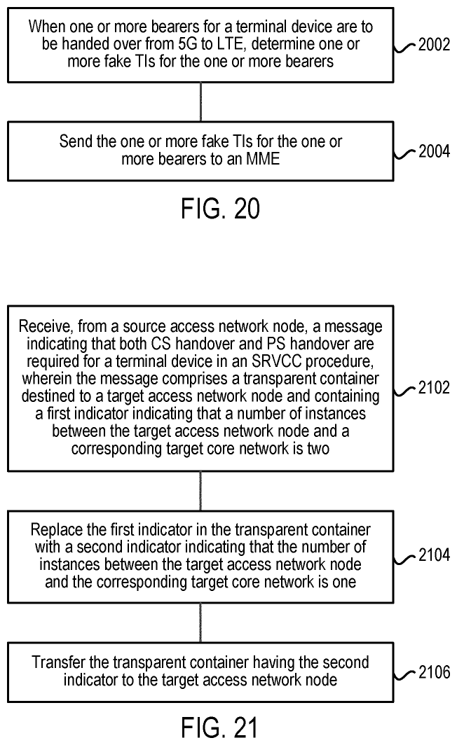

FIG. 20 is a flowchart illustrating a method performed by an AMF according to an embodiment of the disclosure. At block 2002, when one or more bearers for a terminal device are to be handed over from 5G to LTE, the AMF determines one or more fake TIs for the one or more bearers. For example, the fake TIs may be determined by using the existing TI generation mechanism except that the determined fake TIs are not synchronized to the terminal device and other core network node (e.g. the gateway node). At block 2004, the AMF sends the one or more fake TIs for the one or more bearers to an MME. With the method of FIG. 20, it is possible to avoid a failure of an SRVCC procedure to 2G/3G since the fake TIs can be sent by the MME to an SGSN in a Forward Relocation Request message in the SRVCC procedure.

As an exemplary example for the method of FIG. 20, the source AMF may fake the missing TI(s) for the bearer(s), in order to handover them to 2/3G. Specifically, the source AMF may fake the TI for each bearer when mobility from 5GS to LTE. Then these bearers will have TIs when moving to LTE. It will make the following SRVCC with PS handover procedure successful. But these bearers are still deactivated by the GGSN in 2/3G after the PS handover.

FIG. 21 is a flowchart illustrating a method performed by an MME according to an embodiment of the disclosure. At block 2102, the MME receives, from a source access network node, a message indicating that both CS handover and PS handover are required for a terminal device in an SRVCC procedure. The message comprises a transparent container destined to a target access network node. The transparent container contains a first indicator indicating that a number of instances between the target access network node and a corresponding target core network is two. For example, the source access network node may be an eNB and the target access network node may be an RNC. The message may be a Handover Required message having an IE “SRVCC HO Indication” with value “PS and CS”. The transparent container may be a “Source to Target Transparent Container” and the first indicator may be an IE “Number of Iu Instances” whose value is 2 meaning CS+PS. At block 2104, the MME replaces the first indicator in the transparent container with a second indicator indicating that the number of instances between the target access network node and the corresponding target core network is one. For example, the second indicator may be an IE “Number of Iu Instances” whose value is 1 meaning CS only. At block 2106, the MME transfers the transparent container having the second indicator to the target access network node. For example, the transparent container may be transferred via an MSC server/MGW and the target MSC. With the method of FIG. 21, it is possible to avoid a failure of an SRVCC procedure to 2G/3G so as to improve the end user experience especially for voice service.

As an exemplary example for the method of FIG. 21, the MME may change the “Number of Iu Instances” in IE “Source to Target Transparent Container”. Specifically, after receiving a Handover Required message from the eNB, if all of E-RABs cannot move to 2/3G, the MME will modify the “Number of Iu Instances” of IE “Source to Target Transparent Container” in the Handover Required message sent by the eNodeB, from value 2 (CS+PS) to 1 (CS only). Then the target RNC will not wait for PS handover but think it is CS handover only so that the voice bearer can be handed over to 2/3G without PS handover.

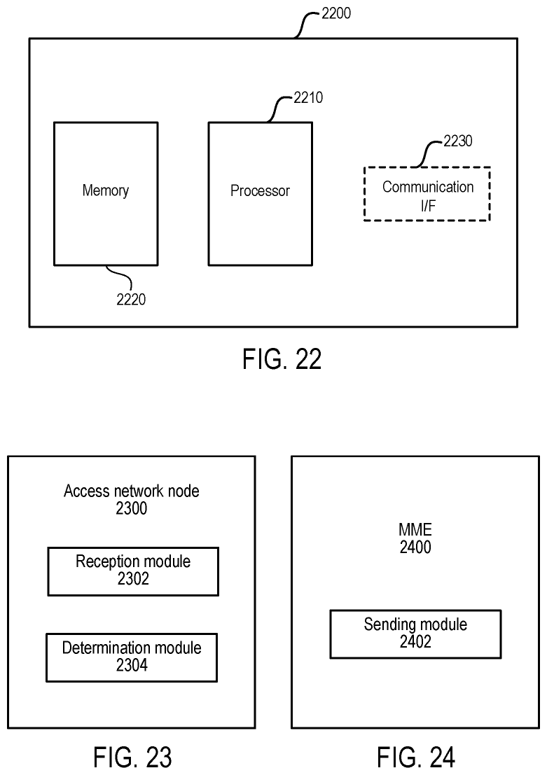

FIG. 22 is a block diagram showing an apparatus suitable for use in practicing some embodiments of the disclosure. For example, any one of the access network node, the MME and the AMF described above may be implemented through the apparatus 2200. As shown, the apparatus 2200 may include a processor 2210, a memory 2220 that stores a program, and optionally a communication interface 2230 for communicating data with other external devices through wired and/or wireless communication.

The program includes program instructions that, when executed by the processor 2210, enable the apparatus 2200 to operate in accordance with the embodiments of the present disclosure, as discussed above. That is, the embodiments of the present disclosure may be implemented at least in part by computer software executable by the processor 2210, or by hardware, or by a combination of software and hardware.

The memory 2220 may be of any type suitable to the local technical environment and may be implemented using any suitable data storage technology, such as semiconductor based memory devices, flash memories, magnetic memory devices and systems, optical memory devices and systems, fixed memories and removable memories. The processor 2210 may be of any type suitable to the local technical environment, and may include one or more of general purpose computers, special purpose computers, microprocessors, digital signal processors (DSPs) and processors based on multi-core processor architectures, as non-limiting examples.

FIG. 23 is a block diagram showing an access network node according to an embodiment of the disclosure. As shown, the access network node 2300 comprises a reception module 2302 and a determination module 2304. The reception module 2302 may be configured to receive, from an MME, information indicating that one or more bearers for a terminal device cannot be handed over to one or more RATs different than LTE. The determination module 2304 may be configured to determine whether to perform a PS handover for the terminal device based on the information.

FIG. 24 is a block diagram showing an MME according to an embodiment of the disclosure. As shown, the MME 2400 comprises a sending module 2402. The sending module 2402 may be configured to send, to an access network node, information indicating that one or more bearers for a terminal device cannot be handed over to one or more RATs different than LTE.

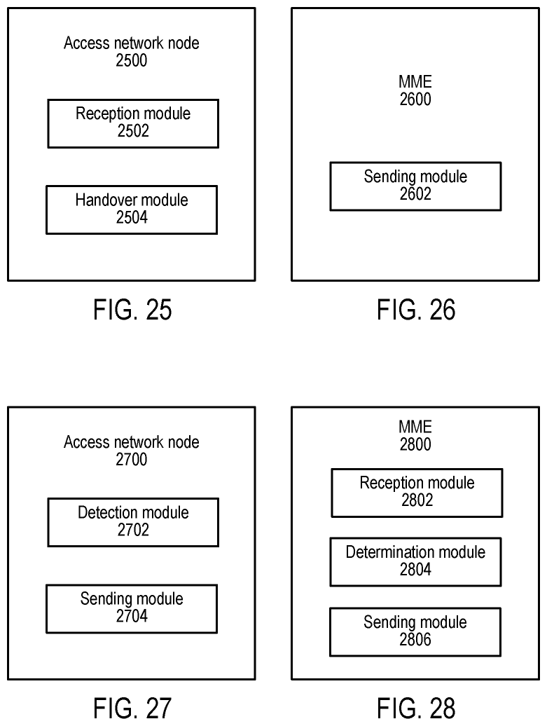

FIG. 25 is a block diagram showing an access network node according to an embodiment of the disclosure. As shown, the access network node 2500 comprises a reception module 2502 and a handover module 2504. The reception module 2502 may be configured to receive, from an MME, an indication about whether both CS handover and PS handover of SRVCC to 2G/3G or only CS handover of SRVCC to 2G/3G is supported by a terminal device. The handover module 2504 may be configured to perform at least one handover to 2G/3G for the terminal device based on the indication.

FIG. 26 is a block diagram showing an MME according to an embodiment of the disclosure. As shown, the MME 2600 comprises a sending module 2602. The sending module 2602 may be configured to send, to an access network node, an indication about whether both CS handover and PS handover of SRVCC to 2G/3G or only CS handover of SRVCC to 2G/3G is supported by a terminal device.

FIG. 27 is a block diagram showing an access network node according to an embodiment of the disclosure. As shown, the access network node 2700 comprises a detection module 2702 and a sending module 2704. The detection module 2702 may be configured to detect a trigger event that a first request for a CS handover has been received, but a second request for a PS handover has not been received within a predetermined time period in a case where both the CS handover and the PS handover need to be performed in an SRVCC procedure. The sending module 2704 may be configured to, in response to the trigger event, send a response for approving the CS handover.

FIG. 28 is a block diagram showing an MME according to an embodiment of the disclosure. As shown, the MME 2800 comprises a reception module 2802, a determination module 2804 and a sending module 2806. The reception module 2802 may be configured to receive, from an access network node, a first message indicating that both CS handover and PS handover are required for a terminal device in an SRVCC procedure. The determination module 2804 may be configured to determine whether none of one or more bearers for the terminal device can be handed over to 2G/3G. The sending module 2806 may be configured to, when determining that none of the one or more bearers for the terminal device can be handed over to 2G/3G, send, to the access network node, a second message indicating a failure of handover preparation due to both CS handover and PS handover to 2G/3G being not supported by the terminal device.

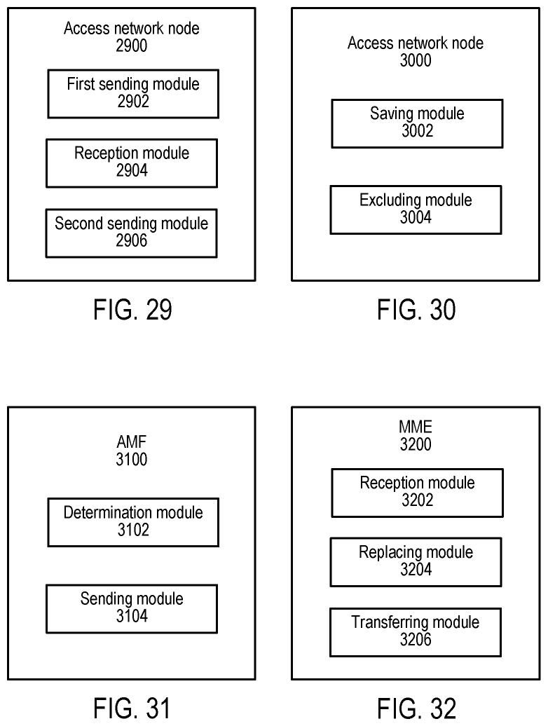

FIG. 29 is a block diagram showing an access network node according to an embodiment of the disclosure. As shown, the access network node 2900 comprises a first sending module 2902, a reception module 2904 and a second sending module 2906. The first sending module 2902 may be configured to send, to an MME, a first message indicating that both CS handover and PS handover are required for a terminal device in an SRVCC procedure. The reception module 2904 may be configured to receive, from the MME, a second message indicating a failure of handover preparation due to both CS handover and PS handover to 2G/3G being not supported by the terminal device. The second sending module 2906 may be configured to send, to the MME, a third message indicating that only CS handover is required for the terminal device in the SRVCC procedure.

FIG. 30 is a block diagram showing an access network node according to an embodiment of the disclosure. As shown, the access network node 3000 may comprise a saving module 3002 and a excluding module 3004. The saving module 3002 may be configured to, when one or more bearers for a terminal device are handed over from 5G to LTE, save information indicating that the one or more bearers cannot be handed over to 2G/3G. The excluding module 3004 may be configured to exclude the one or more bearers indicated by the saved information, when determining which bearer(s) for the terminal device are to be handed over to 2G/3G in a PS handover or in an SRVCC procedure.

FIG. 31 is a block diagram showing an AMF according to an embodiment of the disclosure. As shown, the AMF 3100 may comprise a determination module 3102 and a sending module 3104. The determination module 3102 may be configured to, when one or more bearers for a terminal device are to be handed over from 5G to LTE, determine one or more fake TIs for the one or more bearers. The sending module 3104 may be configured to send the one or more fake TIs for the one or more bearers to an MME.

FIG. 32 is a block diagram showing an MME according to an embodiment of the disclosure. As shown, the MME 3200 comprises a reception module 3202, a replacing module 3204 and a transferring module 3206. The reception module 3202 may be configured to receive, from a source access network node, a message indicating that both CS handover and PS handover are required for a terminal device in an SRVCC procedure. The message may comprise a transparent container destined to a target access network node. The transparent container may contain a first indicator indicating that a number of instances between the target access network node and a corresponding target core network is two. The replacing module 3204 may be configured to replace the first indicator in the transparent container with a second indicator indicating that the number of instances between the target access network node and the corresponding target core network is one. The transferring module 3206 may be configured to transfer the transparent container having the second indicator to the target access network node. The modules described above may be implemented by hardware, or software, or a combination of both.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements. It should be noted that two blocks shown in succession in the above figures may, in fact, be executed substantially concurrently, or the blocks may sometimes be executed in the reverse order, depending upon the functionality involved.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method performed by an access network node, comprising:
receiving, from a mobility management entity MME) information indicating that one or more bearers for a terminal device cannot be handed over to one or more radio access technologies (RATs) different than long term evolution (LTE); and
determining whether to perform a packet switched (PS) handover for the terminal device based on the information.

2. The method of claim 1, further comprising:
determining how to perform the PS handover for the terminal device based on the information.

3. The method of claim 1, wherein the information indicates that the one or more bearers for the terminal device cannot be handed over to 2nd generation, 2G/3rd generation, 3G, or 5th generation, 5G.

4. The method of claim 1, wherein the one or more bearers comprise at least one first bearer established in LTE and capable of interworking with 5th generation system (5GS); and
wherein the information indicates that the at least one first bearer cannot be handed over to 2G/3G.

5. The method of claim 1, wherein the one or more bearers comprise at least one second bearer established in LTE and incapable of interworking with 5GS; and
wherein the information indicates that the at least one second bearer cannot be handed over to 5G.

6. The method of claim 1, wherein the one or more bearers comprise at least one third bearer handed over from 5G to LTE; and
wherein the information indicates that the at least one third bearer cannot be handed over to 2G/3G.

7. The method of claim 1, wherein the one or more bearers comprise at least one fourth bearer handed over from 2G/3G to LTE; and
wherein the information indicates that the at least one fourth bearer cannot be handed over to 5G.

8. The method of claim 1, wherein determining whether to perform a PS handover for the terminal device based on the information comprises:
when the information indicates that none of the one or more bearers can be handed over to 2G/3G or 5G, determining not to perform a PS handover to 2G/3G or 5G for the one or more bearers; and/or
when the information indicates that at least one of the one or more bearers can be handed over to 2G/3G or 5G, determining to perform a PS handover to 2G/3G or 5G for the at least one bearer.

9. The method of claim 8, wherein the PS handover is associated with a single radio voice call continuity procedure.

10. The method of claim 2, wherein determining how to perform the PS handover for the terminal device based on the information comprises:
determining a target radio access network (RAN) for the PS handover based on the information.

11. The method of claim 1, wherein the information is received in one of:
an evolved radio access bearer (E-RAB) Setup Request; an Initial Context Setup Request; or a Handover Request.

12. A method performed by a mobility management entity (MME) comprising:
sending, to an access network node, information indicating that one or more bearers for a terminal device cannot be handed over to one or more radio access technologies (RATs) different than long term evolution (LTE).

13. The method of claim 12, wherein the information indicates that the one or more bearers for the terminal device cannot be handed over to 2nd generation, 2G/3rd generation, 3G, or 5th generation, 5G.

14. The method of claim 12, wherein the one or more bearers comprise at least one first bearer established in LTE and capable of interworking with 5th generation system (5Gs); and
wherein the information indicates that the at least one first bearer cannot be handed over to 2G/3G.

15. The method of claim 12, wherein the one or more bearers comprise at least one second bearer established in LTE and incapable of interworking with 5GS; and
wherein the information indicates that the at least one second bearer cannot be handed over to 5G.

16. The method of claim 12, wherein the one or more bearers comprise at least one third bearer handed over from 5G to LTE; and
wherein the information indicates that the at least one third bearer cannot be handed over to 2G/3G.

17. The method of claim 12, wherein the one or more bearers comprise at least one fourth bearer handed over from 2G/3G to LTE; and
wherein the information indicates that the at least one fourth bearer cannot be handed over to 5G.

18. The method of claim 12, wherein the information is sent in one of: an evolved radio access bearer, E-RAB Setup Request; an Initial Context Setup Request; and a Handover Request.

19. A method performed by an access and mobility management function (AMF), comprising:
when one or more bearers for a terminal device are to be handed over from 5th generation, 5G, to long term evolution (LTE) determining one or more fake transaction identifiers, TIs, for the one or more bearers; and
sending the one or more fake TIs for the one or more bearers to a mobility management entity (MME).

20. An access network node comprising:
at least one processor; and
at least one memory, the at least one memory containing instructions executable by the at least one processor, whereby the access network node is operative to:
receive, from a mobility management entity MME) information indicating that one or more bearers for a terminal device cannot be handed over to one or more radio access technologies, RATs, different than long term evolution, LTE; and
determine whether to perform a packet switched, PS, handover for the terminal device based on the information.

21. (canceled)

22. A mobility management entity (MME), comprising:
at least one processor; and
at least one memory, the at least one memory containing instructions executable by the at least one processor, whereby the MME is operative to:
send, to an access network node, information indicating that one or more bearers for a terminal device cannot be handed over to one or more radio access technologies (RATs) different than long term evolution (LTE).

23. (canceled)

24. An access and mobility management function (AMF), comprising:
at least one processor; and
at least one memory, the at least one memory containing instructions executable by the at least one processor, wherein the AMF is operative to:
when one or more bearers for a terminal device are to be handed over from 5th generation to long term evolution (LTE) determine one or more fake transaction identifiers (Tis) for the one or more bearers; and
send the one or more fake TIs for the one or more bearers to a mobility management entity.

25. (canceled)
